(19) United States
(12) Patent Application Publication
(10) Pub. No.: US 2026/0222583 A1
(43) Pub. Date: Jul. 30, 2026

(54) Pyramid Lattice Vector Quantization For Coding Motion Vector Differences

(71) Applicant: Google LLC, Mountain View, CA (US)

(72) Inventors: Mohammed Golam Sarwer, San Jose, CA (US); Jianle Chen, San Diego, CA (US); Rachel Barker, Cambridge (GB); Debargha Mukherjee, Cupertino, CA (US)

(21) Appl. No.: 19/141,624

(22) PCT Filed: Jan. 23, 2024
(86) PCT No.: PCT/US2024/012557

§ 371 Date: Jun. 20, 2025

Related U.S. Application Data
(60) Provisional application No. 63/440,729, filed on Jan. 24, 2023.

(51) Int. Cl. H04N 19/137; H04N 19/13; H04N 19/176; H04N 19/91

(52) U.S. Cl. CPC H04N 19/137; H04N 19/13; H04N 19/176; H04N 19/91

(57) ABSTRACT

Coding using pyramid lattice vector quantization for coding motion vector differences includes obtaining a motion vector difference by subtracting a predicted motion vector from a motion vector used to encode the current block and encoding the motion vector difference by determining a shell index as a sum of an absolute value of a horizontal component of the motion vector difference and an absolute value of a vertical component of the motion vector difference, determining a quadrant value in accordance with the motion vector, in response to a determination that the shell index is greater than one, determining a distance value, including encoded block data in an encoded bitstream, and outputting the encoded bitstream.

### CROSS-REFERENCE TO RELATED APPLICATION(S)

This application claims priority to and the benefit of U.S. Provisional Application Patent Ser. No. 63/440,729, filed Jan. 24, 2023, the entire disclosure of which is hereby incorporated by reference.

### BACKGROUND

Digital images and video can be used, for example, on the internet, for remote business meetings via video conferencing, high-definition video entertainment, video advertisements, or sharing of user-generated content. Due to the large amount of data involved in transferring and processing image and video data, high-performance compression may be advantageous for transmission and storage. Accordingly, it would be advantageous to provide high-resolution image and video transmitted over communications channels having limited bandwidth.

### SUMMARY

This application relates to encoding and decoding of image data, video stream data, or both for transmission, storage, or both. Disclosed herein are aspects of systems, methods, and apparatuses for encoding and decoding using pyramid lattice vector quantization for coding motion vector differences.

Variations in these and other aspects will be described in additional detail hereafter.

An aspect is a method for encoding using pyramid lattice vector quantization for coding motion vector differences. Encoding using pyramid lattice vector quantization for coding motion vector differences includes obtaining an input video stream, generating encoded frame data, including the encoded frame data in an encoded bitstream, and outputting the encoded bitstream. Generating the encoded frame data includes obtaining a current frame from the input video stream, obtaining a current block from the current frame, and generating encoded block data. Generating the encoded block data includes obtaining a motion vector difference by subtracting a predicted motion vector from a motion vector used to encode the current block, and encoding the motion vector difference. Encoding the motion vector difference includes determining a shell index as a sum of an absolute value of a horizontal component of the motion vector difference and an absolute value of a vertical component of the motion vector difference, obtaining an encoded shell index by encoding the shell index, and, in response to a determination that the shell index is greater than zero, determining a quadrant value in accordance with the motion vector. Encoding the motion vector difference includes obtaining an encoded quadrant value by encoding the quadrant value using adaptive entropy coding using an alphabet having a size of four, and, in response to a determination that a parameter is greater than one, wherein the determination that the parameter is greater than one includes using the shell index as the parameter, determining, as a distance value, a result of subtracting a result of the quadrant value modulo two from the absolute value of the vertical component of the motion vector difference, and obtaining an encoded distance value by encoding the distance value using quasi-uniform coding using an alphabet having a size of the parameter.

Another aspect is an apparatus for encoding using pyramid lattice vector quantization for coding motion vector differences, the apparatus comprising a memory including computer executable instructions for encoding an input video stream, and a processor that executes the instructions to obtain an input video stream, generate encoded frame data, include the encoded frame data in an encoded bitstream, and output the encoded bitstream. To generate the encoded frame data the processor executes the instructions to obtain a current frame from the input video stream, obtain a current block from the current frame, and generate encoded block data. To generate the encoded block data the processor executes the instructions to obtain a motion vector difference by subtracting a predicted motion vector from a motion vector used to encode the current block and encode the motion vector difference. To encode the motion vector difference the processor executes the instructions to determine a shell index as a sum of an absolute value of a horizontal component of the motion vector difference and an absolute value of a vertical component of the motion vector difference, obtain an encoded shell index by encoding the shell index, and, in response to a determination that the shell index is greater than zero, determine a quadrant value in accordance with the motion vector. To encode the motion vector difference the processor executes the instructions to obtain an encoded quadrant value by encoding the quadrant value using adaptive entropy coding using an alphabet having a size of four, and, in response to a determination that a parameter is greater than one, wherein the determination that the parameter is greater than one includes using the shell index as the parameter, determine, as a distance value, a result of subtracting a result of the quadrant value modulo two from the absolute value of the vertical component of the motion vector difference, and obtain an encoded distance value by encoding the distance value using quasi-uniform coding using an alphabet having a size of the parameter.

Another aspect is a method for decoding using pyramid lattice vector quantization for coding motion vector differences. Decoding using pyramid lattice vector quantization for coding motion vector differences includes obtaining an encoded bitstream, generating reconstructed frame data, including the reconstructed frame data in an output video stream, and outputting the output video stream. Generating the reconstructed frame data includes identifying a current frame, identifying a current block from the current frame, and generating reconstructed block data by decoding the current block from an encoded bitstream, wherein decoding the current block includes obtaining a motion vector for decoding the current block by obtaining a shell index by decoding the shell index from the encoded bitstream, in response to a determination that the shell index is zero, using a zero motion vector as the motion vector, and, in response to a determination that the shell index is greater than zero, obtaining a quadrant value by decoding the quadrant value from the encoded bitstream, in response to a determination that the shell index is less than or equal to one, identifying a distance value of zero, in response to a determination that the shell index is greater than one, identifying the distance value by decoding the distance value from the encoded bitstream, in response to a determination that the quadrant value is zero, identify the distance value as a vertical component of the motion vector, and identifying a result of subtracting the distance value from the shell index as a horizontal component of the motion vector, in response to a determination that the quadrant value is one, identify, as the vertical component of the motion vector, a sum of one and the distance value, and identifying, as the horizontal component of the motion vector, a sum of one, the distance value, and an additive inverse of the shell index, in response to a determination that the quadrant value is two, identify, as the vertical component of the motion vector, an additive inverse of the distance value, and identifying, as the horizontal component of the motion vector, a sum of the distance value, and an additive inverse of the shell index, and, in response to a determination that the quadrant value is three, identify, as the vertical component of the motion vector, a result of subtracting one from an additive inverse of the distance value, and identifying, as the horizontal component of the motion vector, a result of subtracting one from a result of subtracting the distance value from the shell index.

Another aspect is an apparatus for decoding using pyramid lattice vector quantization for coding motion vector differences, the apparatus comprising a memory including computer executable instructions for decoding an encoded video stream, and a processor that executes the instructions to obtain an encoded bitstream, generate reconstructed frame data, include the reconstructed frame data in an output video stream, and output the output video stream. To generate the reconstructed frame data the processor executes the instructions to identify a current frame, identify a current block from the current frame, and generate reconstructed block data by decoding the current block from an encoded bitstream, wherein to decode the current block the processor executes the instructions to obtain a motion vector for decoding the current block by obtaining a shell index by decoding the shell index from the encoded bitstream, in response to a determination that the shell index is zero, use a zero motion vector as the motion vector, and, in response to a determination that the shell index is greater than zero, obtain a quadrant value by decoding the quadrant value from the encoded bitstream, in response to a determination that the shell index is less than or equal to one, identify a distance value of zero, in response to a determination that the shell index is greater than one, identify the distance value by decoding the distance value from the encoded bitstream, in response to a determination that the quadrant value is zero, identify the distance value as a vertical component of the motion vector, and identify a result of subtracting the distance value from the shell index as a horizontal component of the motion vector, in response to a determination that the quadrant value is one, identify, as the vertical component of the motion vector, a sum of one and the distance value, and identify, as the horizontal component of the motion vector, a sum of one, the distance value, and an additive inverse of the shell index, in response to a determination that the quadrant value is two, identify, as the vertical component of the motion vector, an additive inverse of the distance value, and identify, as the horizontal component of the motion vector, a sum of the distance value, and an additive inverse of the shell index, and, in response to a determination that the quadrant value is three, identify, as the vertical component of the motion vector, a result of subtracting one from an additive inverse of the distance value, and identify, as the horizontal component of the motion vector, a result of subtracting one from a result of subtracting the distance value from the shell index.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a block diagram of a representation of a portion of a frame in accordance with implementations of this disclosure.

FIG. 7 is a flowchart diagram of an example of encoding using pyramid lattice vector quantization for coding motion vector differences in accordance with implementations of this disclosure.

FIG. 8 is a block diagram of an example of pyramidal shells and quadrants.

FIG. 9 is a flowchart diagram of an example of decoding using pyramid lattice vector quantization for coding motion vector differences in accordance with implementations of this disclosure.

### DETAILED DESCRIPTION

Image and video compression schemes may include breaking an image, or frame, into smaller portions, such as blocks, and generating an output bitstream using techniques to minimize the bandwidth utilization of the information included for each block in the output. In some implementations, the information included for each block in the output may be limited by reducing spatial redundancy, reducing temporal redundancy, or a combination thereof. For example, temporal or spatial redundancies may be reduced by predicting a frame, or a portion thereof, based on information available to both the encoder and decoder, and including information representing a difference, or residual, between the predicted frame and the original frame in the encoded bitstream. The residual information may be further compressed by transforming the residual information into transform coefficients (e.g., energy compaction), quantizing the transform coefficients, and entropy coding the quantized transform coefficients. Other coding information, such as motion information, may be included in the encoded bitstream, which may include transmitting differential information based on predictions of the encoding information, which may be entropy coded to further reduce the corresponding bandwidth utilization. An encoded bitstream can be decoded to reconstruct the blocks and the source images from the limited information. In some implementations, the accuracy, efficiency, or both, of coding a block using either inter-prediction or intra-prediction may be limited.

Some block-based hybrid video coding techniques, or codecs, may be limited to reducing temporal redundancy using a translational motion model, which may inefficiently or inaccurately represent non-translational motion. Some block-based hybrid video coding techniques, or codecs, may include warped motion video coding, including warped motion compensation, which may improve the efficiency, accuracy, or both, relative to block-based hybrid video coding techniques that are limited to reducing temporal redundancy using a translational motion model, with respect to non-translational motion. For example, some block-based hybrid video coding techniques may include warped motion video coding using a global warp motion model, a local warp motion model, or both.

Some block-based hybrid video coding techniques, or codecs, which include warped motion video coding may signal warped motion model parameters inefficiently. For example, some block-based hybrid video coding techniques, or codecs, which include warped motion video coding may signal warped motion model parameters, such as global affine motion parameters, on a per-frame or a per-group-of-frames basis. Some block-based hybrid video coding techniques, or codecs, which include warped motion video coding may omit signaling warped motion model parameters, such as warped motion model parameters for a local warp motion model.

The encoding and decoding using pyramid lattice vector quantization for coding motion vector differences described herein improves on video coding techniques, or codecs, by signaling warped motion model parameters at the superblock, or superblock group, level, wherein the resource utilization associated with signaling warped motion model parameters at the superblock, or superblock group, level is reduced by temporal propagation of the motion field.

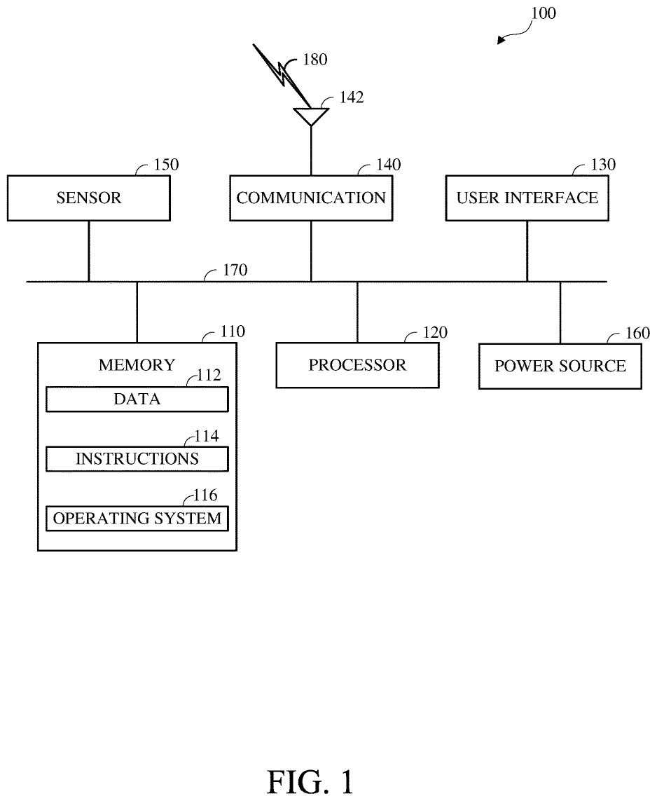

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable storage medium or non-transitory computer-readable storage medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input audio data, encoded audio data, decoded audio data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, which may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, 100 the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

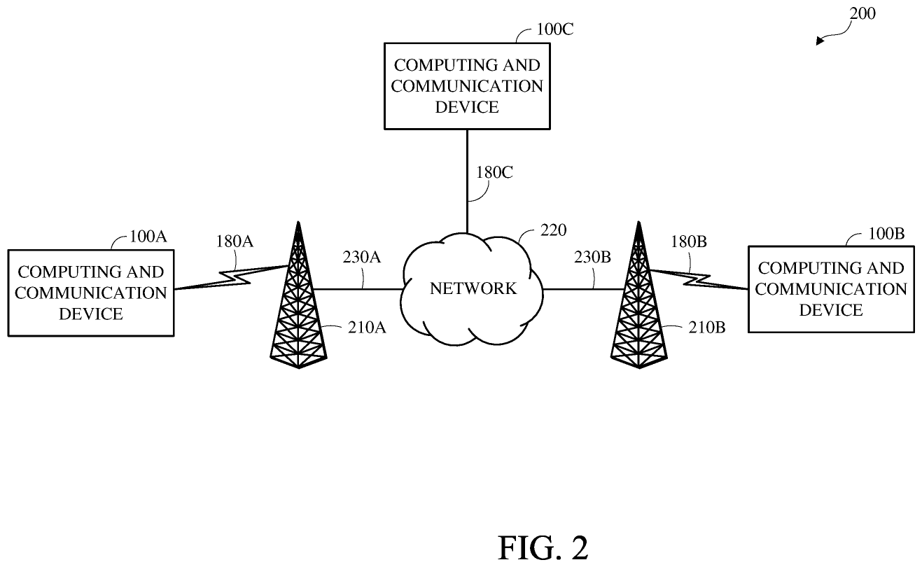

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some, or all, of the functions of a user device, or some or all of the functions of a server and a user device. For example, the server computing and communication device 100C may receive, encode, process, store, transmit, or a combination thereof audio data and one or both of the computing and communication device 100A and the computing and communication device 100B may receive, decode, process, store, present, or a combination thereof the audio data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VOIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communicating devices, networks, and access points.

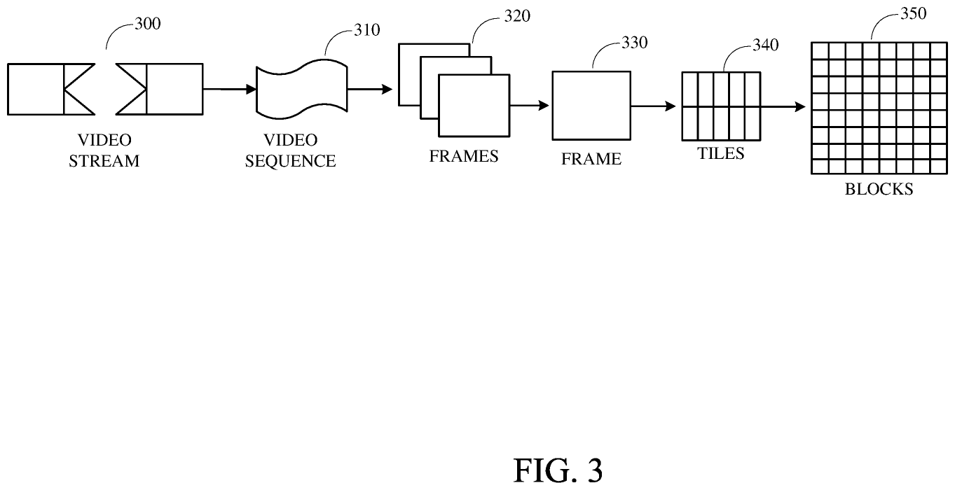

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

Each frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. Each of the tiles 340 may be a rectangular region of the frame that can be coded independently. Each of the tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

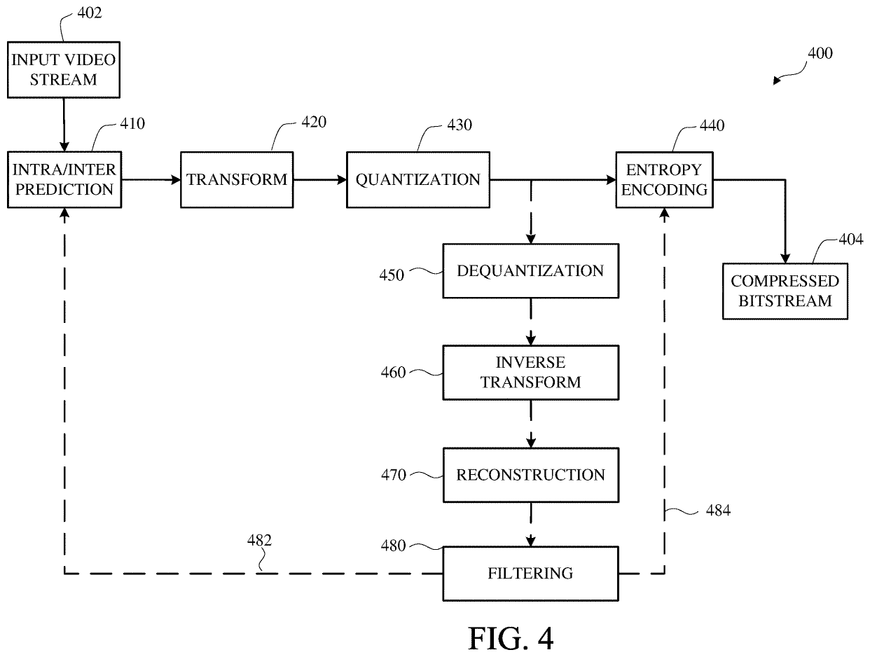

FIG. 4 is a block diagram of an encoder 400 in accordance with implementations of this disclosure. Encoder 400 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3, to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference portion of the reference frame.

The intra/inter prediction unit 410 may subtract the prediction block from the current block (raw block) to produce a residual block. The transform unit 420 may perform a block-based transform, which may include transforming the residual block into transform coefficients in, for example, the frequency domain. Examples of block-based transforms include the Karhunen-Loeve Transform (KLT), the Discrete Cosine Transform (DCT), the Singular Value Decomposition Transform (SVD), and the Asymmetric Discrete Sine Transform (ADST). In an example, the DCT may include transforming a block into the frequency domain. The DCT may include using transform coefficient values based on spatial frequency, with the lowest frequency (i.e., DC) coefficient at the top-left of the matrix and the highest frequency coefficient at the bottom-right of the matrix.

The quantization unit 430 may convert the transform coefficients into discrete quantum values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the block, which may include the type of prediction used, motion vectors, and quantizer values, can be output to the compressed bitstream 404. The compressed bitstream 404 can be formatted using various techniques, such as run-length encoding (RLE) and zero-run coding.

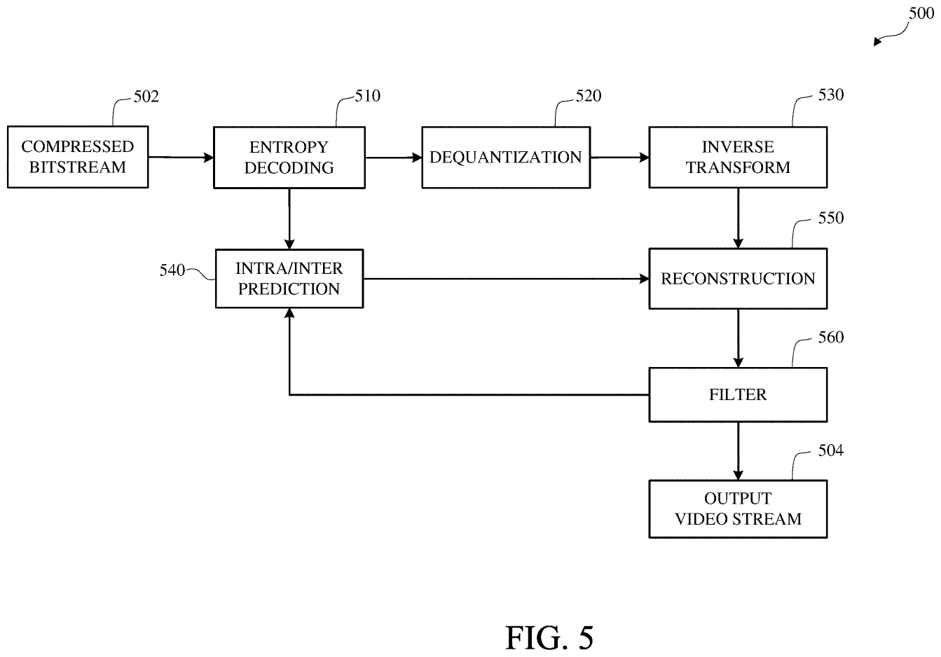

The reconstruction path can be used to maintain reference frame synchronization between the encoder 400 and a corresponding decoder, such as the decoder 500 shown in FIG. 5. The reconstruction path may be similar to the decoding process discussed below and may include decoding the encoded frame, or a portion thereof, which may include decoding an encoded block, which may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a decoded block. The filtering unit 480 can be applied to the decoded block to generate a reconstructed block, which may reduce distortion, such as blocking artifacts. Although one filtering unit 480 is shown in FIG. 4, filtering the decoded block may include loop filtering, deblocking filtering, or other types of filtering or combinations of types of filtering. The reconstructed block may be stored or otherwise made accessible as a reconstructed block, which may be a portion of a reference frame, for encoding another portion of the current frame, another frame, or both, as indicated by the broken line at 482. Coding information, such as deblocking threshold index values, for the frame may be encoded, included in the compressed bitstream 404, or both, as indicated by the broken line at 484.

Other variations of the encoder 400 can be used to encode the compressed bitstream 404. For example, a non-transform-based encoder 400 can quantize the residual block directly without the transform unit 420. In some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a filtering unit 560, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond to the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a decoded block. The filtering unit 560 can be applied to the decoded block to reduce artifacts, such as blocking artifacts, which may include loop filtering, deblocking filtering, or other types of filtering or combinations of types of filtering, and which may include generating a reconstructed block, which may be output as the output video stream 504.

Other variations of the decoder 500 can be used to decode the compressed bitstream 502. For example, the decoder 500 can produce the output video stream 504 without a deblocking filtering unit.

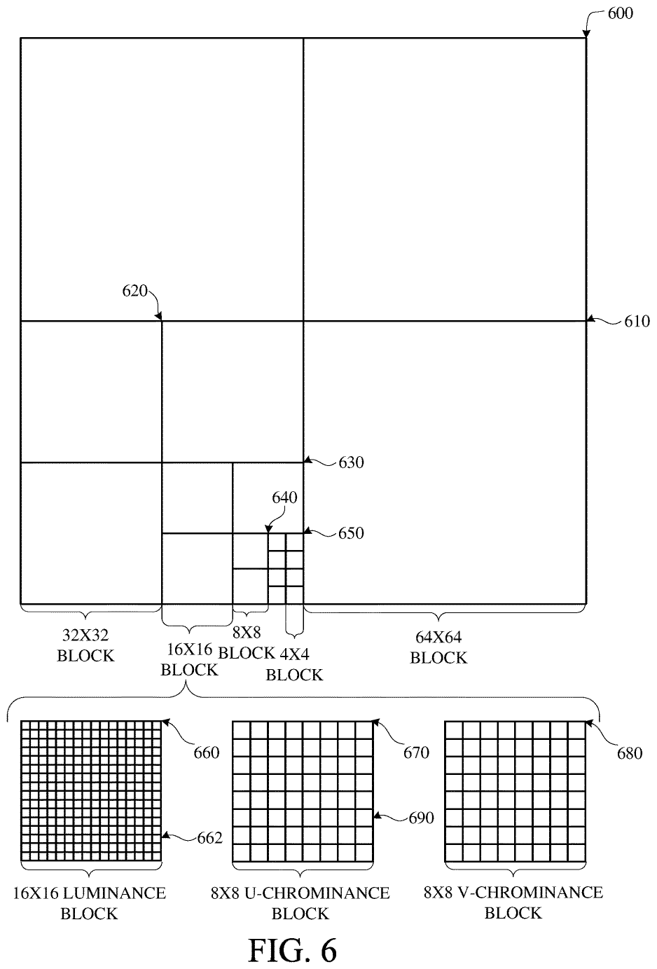

FIG. 6 is a block diagram of a representation of a portion 600 of a frame, such as the frame 330 shown in FIG. 3, in accordance with implementations of this disclosure. As shown, the portion 600 of the frame includes four 64×64 blocks 610, in two rows and two columns in a matrix or Cartesian plane. In some implementations, a 64×64 block may be a maximum coding unit, N=64. Each 64×64 block may include four 32×32 blocks 620. Each 32×32 block may include four 16×16 blocks 630. Each 16×16 block may include four 8×8 blocks 640. Each 8×8 block 640 may include four 4×4 blocks 650. Each 4×4 block 650 may include 16 pixels, which may be represented in four rows and four columns in each respective block in the Cartesian plane or matrix. The pixels may include information representing an image captured in the frame, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used. For example, 32×64 blocks, 64×32 blocks, 16×32 blocks, 32×16 blocks, or any other size blocks may be used. In some implementations, N×2N blocks, 2N×N blocks, or a combination thereof may be used.

In some implementations, video coding may include ordered block-level coding. Ordered block-level coding may include coding blocks of a frame in an order, such as raster-scan order, wherein blocks may be identified and processed starting with a block in the upper left corner of the frame, or portion of the frame, and proceeding along rows from left to right and from the top row to the bottom row, identifying each block in turn for processing. For example, the 64×64 block in the top row and left column of a frame may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block may include using quad-tree coding, which may include coding smaller block units within a block in raster-scan order. For example, the 64×64 block shown in the bottom left corner of the portion of the frame shown in FIG. 6, may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, video coding may include compressing the information included in an original, or input, frame by, for example, omitting some of the information in the original frame from a corresponding encoded frame. For example, coding may include reducing spectral redundancy, reducing spatial redundancy, reducing temporal redundancy, or a combination thereof.

In some implementations, reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of a frame and using a relatively small amount of information to represent each corresponding chrominance component for the portion of the frame. For example, a portion of a frame may be represented by a high-resolution luminance component, which may include a 16×16 block of pixels, and by two lower resolution chrominance components, each of which represents the portion of the frame as an 8×8 block of pixels. A pixel may indicate a value, for example, a value in the range from 0 to 255, and may be stored or transmitted using, for example, eight bits. Although this disclosure is described in reference to the YUV color model, any color model may be used.

In some implementations, reducing spatial redundancy may include transforming a block into the frequency domain using, for example, a discrete cosine transform (DCT). For example, a unit of an encoder, such as the transform unit 420 shown in FIG. 4, may perform a DCT using transform coefficient values based on spatial frequency.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different spatial location and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a portion of a reference frame that corresponds to a current block or pixel of a current frame. For example, a reference frame, or a portion of a reference frame, which may be stored in memory, may be searched to identify a portion for generating a prediction to use for encoding a current block or pixel of the current frame with maximal efficiency. For example, the search may identify a portion of the reference frame for which the difference in pixel values between the current block and a prediction block generated based on the portion of the reference frame is minimized and may be referred to as motion searching. In some implementations, the portion of the reference frame searched may be limited. For example, the portion of the reference frame searched, which may be referred to as the search area, may include a limited number of rows of the reference frame. In an example, identifying the portion of the reference frame for generating a prediction may include calculating a cost function, such as a sum of absolute differences (SAD), between the pixels of portions of the search area and the pixels of the current block.

In some implementations, the spatial difference between the location of the portion of the reference frame for generating a prediction in the reference frame and the current block in the current frame may be represented as a motion vector. The difference in pixel values between the prediction block and the current block may be referred to as differential data, residual data, a prediction error, or as a residual block. In some implementations, generating motion vectors may be referred to as motion estimation, and a pixel of a current block may be indicated based on location using Cartesian coordinates as f_{x, y}. Similarly, a pixel of the search area of the reference frame may be indicated based on location using Cartesian coordinates as r_{x, y}. A motion vector (MV) for the current block may be determined based on, for example, a SAD between the pixels of the current frame and the corresponding pixels of the reference frame.

Although described herein with reference to matrix or Cartesian representation of a frame for clarity, a frame may be stored, transmitted, processed, or any combination thereof, in any data structure such that pixel values may be efficiently represented for a frame or image. For example, a frame may be stored, transmitted, processed, or any combination thereof, in a two-dimensional data structure such as a matrix as shown, or in a one-dimensional data structure, such as a vector array. In an implementation, a representation of the frame, such as a two-dimensional representation as shown, may correspond to a physical location in a rendering of the frame as an image. For example, a location in the top left corner of a block in the top left corner of the frame may correspond with a physical location in the top left corner of a rendering of the frame as an image.

In some implementations, block-based coding efficiency may be improved by partitioning input blocks into one or more prediction partitions, which may be rectangular, including square, partitions for prediction coding. In some implementations, video coding using prediction partitioning may include selecting a prediction partitioning scheme from among multiple candidate prediction partitioning schemes. For example, in some implementations, candidate prediction partitioning schemes for a 64×64 coding unit may include rectangular size prediction partitions ranging in sizes from 4×4 to 64×64, such as 4×4, 4×8, 8×4, 8×8, 8×16, 16×8, 16×16, 16×32, 32×16, 32×32, 32×64, 64×32, or 64×64. In some implementations, video coding using prediction partitioning may include a full prediction partition search, which may include selecting a prediction partitioning scheme by encoding the coding unit using each available candidate prediction partitioning scheme and selecting the best scheme, such as the scheme that produces the least rate-distortion error.

In some implementations, encoding a video frame may include identifying a prediction partitioning scheme for encoding a current block, such as block 610. In some implementations, identifying a prediction partitioning scheme may include determining whether to encode the block as a single prediction partition of maximum coding unit size, which may be 64×64 as shown, or to partition the block into multiple prediction partitions, which may correspond with the sub-blocks, such as the 32×32 blocks 620 the 16×16 blocks 630, or the 8×8 blocks 640, as shown, and may include determining whether to partition into one or more smaller prediction partitions. For example, a 64×64 block may be partitioned into four 32×32 prediction partitions. Three of the four 32×32 prediction partitions may be encoded as 32×32 prediction partitions and the fourth 32×32 prediction partition may be further partitioned into four 16×16 prediction partitions. Three of the four 16×16 prediction partitions may be encoded as 16×16 prediction partitions and the fourth 16×16 prediction partition may be further partitioned into four 8×8 prediction partitions, each of which may be encoded as an 8×8 prediction partition. In some implementations, identifying the prediction partitioning scheme may include using a prediction partitioning decision tree.

In some implementations, video coding for a current block may include identifying an optimal prediction coding mode from multiple candidate prediction coding modes, which may provide flexibility in handling video signals with various statistical properties and may improve the compression efficiency. For example, a video coder may evaluate each candidate prediction coding mode to identify the optimal prediction coding mode, which may be, for example, the prediction coding mode that minimizes an error metric, such as a rate-distortion cost, for the current block. In some implementations, the complexity of searching the candidate prediction coding modes may be reduced by limiting the set of available candidate prediction coding modes based on similarities between the current block and a corresponding prediction block. In some implementations, the complexity of searching each candidate prediction coding mode may be reduced by performing a directed refinement mode search. For example, metrics may be generated for a limited set of candidate block sizes, such as 16×16, 8×8, and 4×4, the error metric associated with each block size may be in descending order, and additional candidate block sizes, such as 4×8 and 8×4 block sizes, may be evaluated.

In some implementations, block-based coding efficiency may be improved by partitioning a current residual block into one or more transform partitions, which may be rectangular, including square, partitions for transform coding. In some implementations, video coding, such as video coding using transform partitioning, may include selecting a uniform transform partitioning scheme. For example, a current residual block, such as block 610, may be a 64×64 block and may be transformed without partitioning using a 64×64 transform.

Although not expressly shown in FIG. 6, a residual block may be transform partitioned using a uniform transform partitioning scheme. For example, a 64×64 residual block may be transform partitioned using a uniform transform partitioning scheme including four 32×32 transform blocks, using a uniform transform partitioning scheme including sixteen 16×16 transform blocks, using a uniform transform partitioning scheme including sixty-four 8×8 transform blocks, or using a uniform transform partitioning scheme including two hundred fifty-six 4×4 transform blocks.

In some implementations, video coding, such as video coding using transform partitioning, may include identifying multiple transform block sizes for a residual block using multiform transform partition coding. In some implementations, multiform transform partition coding may include recursively determining whether to transform a current block using a current block size transform or by partitioning the current block and multiform transform partition coding each partition. For example, the bottom left block 610 shown in FIG. 6 may be a 64×64 residual block, and multiform transform partition coding may include determining whether to code the current 64×64 residual block using a 64×64 transform or to code the 64×64 residual block by partitioning the 64×64 residual block into partitions, such as four 32×32 blocks 620, and multiform transform partition coding each partition. In some implementations, determining whether to transform partition the current block may be based on comparing a cost for encoding the current block using a current block size transform to a sum of costs for encoding each partition using partition size transforms.

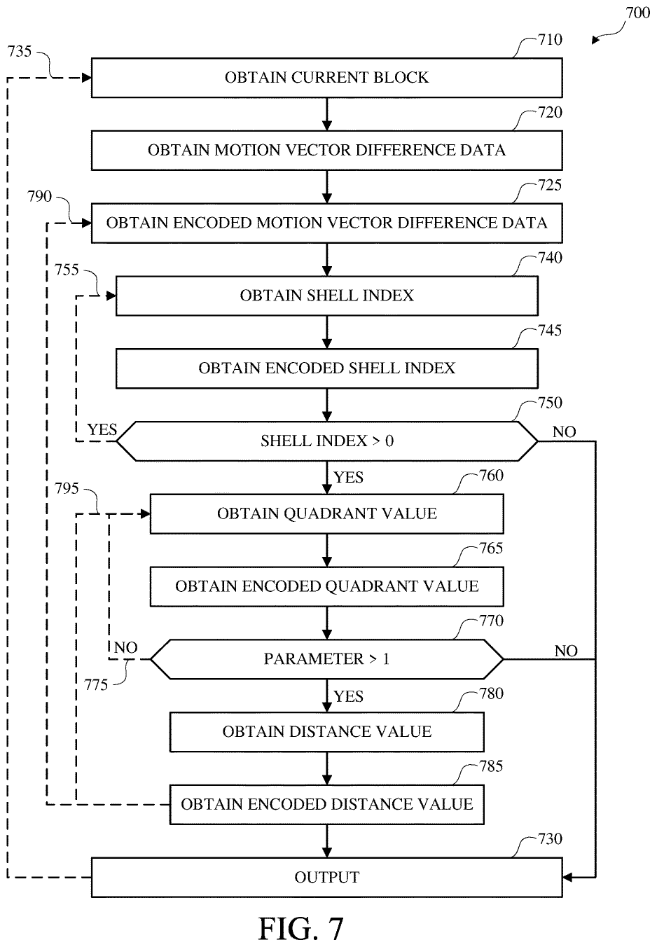

FIG. 7 is a flowchart diagram of an example of encoding using pyramid lattice vector quantization for coding motion vector differences 700 in accordance with implementations of this disclosure. Encoding using pyramid lattice vector quantization for coding motion vector differences 700 may be implemented in an encoder, such as the encoder 400 shown in FIG. 4.

Encoding using pyramid lattice vector quantization for coding motion vector differences 700 includes encoding an input video steam, such as the input video stream 402 shown in FIG. 4, or one or more portions thereof, to generate an encoded (compressed) output bitstream, such as the encoded (compressed) bitstream 404 shown in FIG. 4. In block-based hybrid video coding, to reduce, or minimize, the resource utilization, such as bandwidth utilization, for signaling, storing, or both, compressed, or encoded, video data, redundant data, such as spatially redundant data, temporally redundant data, or both, is omitted or excluded from the compressed, or encoded, data.

Encoding using pyramid lattice vector quantization for coding motion vector differences 700 includes obtaining a current block (at 710), obtaining motion vector difference data (at 720), obtaining encoded motion vector difference data (at 725), and outputting the encoded bitstream (at 730).

A current block is obtained (at 710). Obtaining the current block (at 710) includes obtaining a current frame and obtaining the current block from the current frame), such as in accordance with a block-coding order. The current frame is a frame from the input video, or input video stream. In some implementations, the input video stream may include one or more sequences of frames. A sequence of frames may have a defined cardinality, or number, of frames. For example, the encoder, or a component thereof, such as an intra/inter prediction unit of the encoder, such as the intra/inter prediction unit 410 shown in FIG. 4, may obtain the input video stream. The current frame may be obtained (at 710) subsequent to encoding one or more other frames, such as a frame sequentially preceding the current frame in the input video stream, and generating, or otherwise obtaining, a corresponding reconstructed frame (or frames), or one or more portions thereof, for use as a reference frame (or frames) for encoding the current frame.

Although not shown expressly in FIG. 7, encoding using pyramid lattice vector quantization for coding motion vector differences 700 includes other aspects of video coding for encoding the current block. For example, encoding using pyramid lattice vector quantization for coding motion vector differences 700 includes obtaining, or determining, a prediction coding mode, such as an inter prediction coding mode, which includes obtaining a predicted motion vector, which is an optimal candidate, or reference, motion vector, for the current block, such as from one or more context blocks for the current block, obtaining a motion vector for the current block, obtaining encoded block data by encoding the current block using the motion vector, and including the encoded block data in an encoded, or output, bitstream. The predicted motion vector includes a horizontal (x) component and a vertical (y) component, which may be expressed using Cartesian coordinates. The motion vector includes a horizontal (x) component and a vertical (y) component, which may be expressed using Cartesian coordinates.

Motion vector difference data is obtained (at 720). Obtaining the motion vector difference data includes obtaining a motion vector difference, or differential motion vector, by subtracting the predicted motion vector from the motion vector used to encode the current block. The motion vector difference (MVD), which may be an integer motion vector difference, may be expressed as MVD {iₓ, i_{y}}.

Encoded motion vector difference data is obtained (at 725).

Obtaining the encoded motion vector difference data includes obtaining a shell index (at 740), obtaining an encoded shell index (at 745), determining whether the shell index is greater than zero (at 750), obtaining a quadrant value (at 760), obtaining an encoded quadrant value (at 765), determining whether a parameter is greater than one (at 770), obtaining a distance value (at 780), and obtaining an encoded distance value (at 785).

A shell index, or shell index data, is determined (at 740). Obtaining the shell index (at 740) includes obtaining the shell index (n) as a sum of an absolute value of a horizontal component (|iₓ|) of the motion vector difference and an absolute value of a vertical component (|i_{y}|) of the motion vector difference, which may be expressed as the following:

$$n = \vert {i}_{x} \vert + \vert {i}_{y} \vert .$$

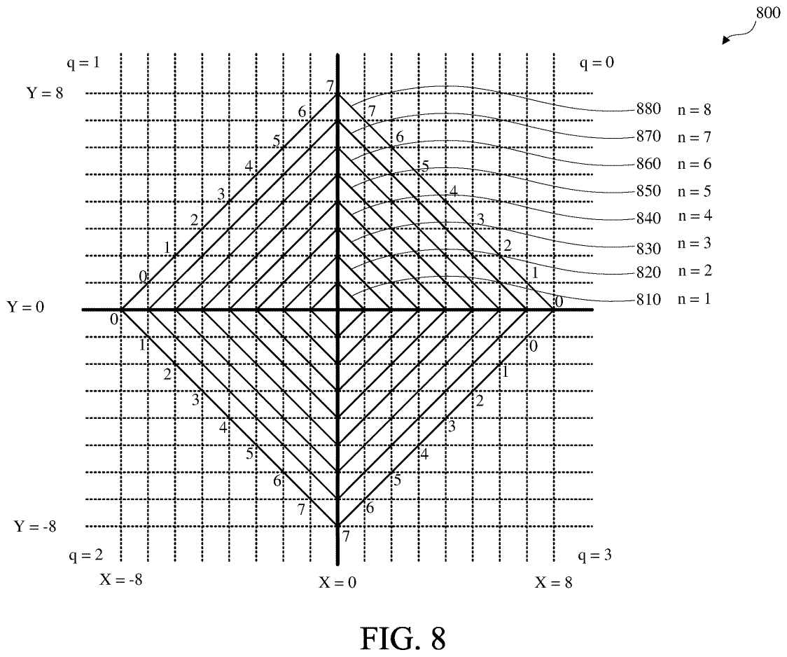

An example of pyramidal shells for a motion vector difference is shown in FIG. 8.

An encoded shell index, or encoded shell index data, is obtained (at 745). In some implementations, encoding the shell index (n) includes encoding the shell index (n) using a Rice-Golomb coder, an Exp-Golomb coder, or a multiclass adaptive entropy coder.

In some encoders, encoding a two-dimensional motion vector difference includes using a joint symbol to indicate which of the horizontal component, the vertical component, or both, of the motion vector difference are non-zero, and using a scalar encoding scheme for encoding the respective non-zero components. The scalar encoding scheme may divide the range of values into multiple value-classes, encode a value-class index, and encode a value within the respective class. Encoding using pyramid lattice vector quantization for coding motion vector differences 700 improves efficiency by omitting using the joint symbol.

In some implementations, encoding using pyramid lattice vector quantization for coding motion vector differences 700 includes class-based shell index coding, wherein coding the shell index (n), other than using class-based shell index coding, is omitted.

Class-based shell index coding includes dividing the shell index (n) into multiple shell-classes, such as using a log 2 scale, encoding the shell-class index, and encoding the shell index (n) within the shell-class.

For example, obtaining the encoded shell index may include obtaining, a shell class index (shell_class_idx), which is a class of the shell index (n), and for a shell index (n) of zero, the shell class index (shell_class_idx) is zero (0). For a shell index (n) other than zero, the shell class index (shell_class_idx) is a result of a sum of one and a result of a ceiling of a base two logarithm of the shell index (n), which may be expressed as the following:

$$shell\_class \_idx = ( n == 0 ) ? 0 : ( ceil ( log 2 ) ( n ) ) + 1 ) .$$

For a shell class index (shell_class_idx), a base value (base_value) is a minimum shell index (n) in the respective shell class. To obtain the base value (base_value), the encoder may determine whether the shell class index (shell_class_idx) is less than two, and, in response to a determination that the shell class index is less than two, the encoder uses the shell class index (shell_class_idx) as the corresponding base value (base_value). In response to a determination that the shell class index (shell_class_idx) is at least, such as greater than or equal to, two (2), the encoder uses, as the corresponding base value (base_value) for the shell class index (shell_class_idx), a result of adding one to a result of left shifting one by a result of subtracting two from the shell class index (shell_class_idx), which may be expressed as the following:

$$base\_value = ( shell\_class \_idx < 2 ) ? shell\_class \_idx : 1 + 1 ≪ ( shell\_class \_idx - 2 ) .$$

Encoding the shell index (n) within the shell-class includes obtaining, as a shell offset index (shell_offset_index), a result of subtracting the base value (base_value) from the shell index (n), which may be expressed as the following:

$$shell\_offset \_index = n - base\_value .$$

The encoder encodes the shell class index (shell_class_idx) to obtain an encoded shell class index and includes the encoded shell class index in the encoded bitstream.

The encoder determines whether the shell class index (shell_class_idx) is greater than two (2). In response to a determination that the shell class index (shell_class_idx) is greater than two (shell_class_idx>2), the encoder encodes the shell offset index (shell_offset_index) using an alphabet having a size of a result of subtracting two from the shell class index (shell_class_idx). In response to a determination that the shell class index (shell_class_idx) is less than or equal to two (shell_class_idx<=2), the encoder determines that the shell offset index (shell_offset_index) is zero (0) and the encoder omits, or excludes, signaling the shell offset index (shell_offset_index).

Whether the shell index (n) is greater than zero is determined (at 750).

In some implementations, the shell index (n) is greater than zero.

In some implementations, the shell index (n) may be zero, and obtaining the quadrant value (at 760), obtaining the encoded quadrant value (at 765), determining whether the parameter is greater than one (at 770), obtaining the distance value (at 780), and obtaining the encoded distance value (at 785), may be omitted or excluded for the current block, as indicated by the directional line labeled “NO” from determining whether the shell index (n) is greater than zero (at 750) to outputting the encoded bitstream (at 730).

A quadrant value, or quadrant value data, is obtained (at 760). For example, as shown in FIG. 7, the quadrant value (q) is obtained (at 760) in response to a determination that the shell index (n) is greater than zero (at 750). The quadrant value (q), which is a 4-ary symbol in a range from zero to three ([0,3]) indicates a quadrant in which the motion vector difference (MVD {iₓ, i_{y}}) results. An example of quadrants is shown in FIG. 8.

In some implementations, obtaining the quadrant value (q) includes obtaining zero (0) as the quadrant value (q) in response to determining that the horizontal component (iₓ) of the motion vector difference is greater than zero and determining that the vertical component (i_{y}) of the motion vector difference is greater than or equal to zero, which may be expressed as the following:

$$q = 0 , if ( {i}_{X} > 0 and {i}_{y} >= 0 ) .$$

In some implementations, obtaining the quadrant value (q) includes obtaining one (1) as the quadrant value (q) in response to determining that the horizontal component (iₓ) of the motion vector difference is less than or equal to zero and determining that the vertical component (i_{y}) of the motion vector difference is greater than zero, which may be expressed as the following:

$$q = 1 , if ( {i}_{X} <= 0 and {i}_{y} > 0 ) .$$

In some implementations, obtaining the quadrant value (q) includes obtaining two (2) as the quadrant value (q) in response to determining that the horizontal component (iₓ) of the motion vector difference is less than zero and determining that the vertical component (i_{y}) of the motion vector difference is less than or equal to zero, which may be expressed as the following:

$$q = 2 , if ( {i}_{X} < 0 and {i}_{y} <= 0 ) .$$

In some implementations, obtaining the quadrant value (q) includes obtaining three (3) as the quadrant value (q) in response to determining that the horizontal component (iₓ) of the motion vector difference is greater than or equal to zero and determining that the vertical component (i_{y}) of the motion vector difference is less than zero, which may be expressed as the following:

$$q = 3 , if ( {i}_{X} >= 0 and {i}_{y} < 0 ) .$$

An encoded quadrant value, or encoded quadrant value data, is obtained (at 765). The quadrant value (q) may be encoded using adaptive entropy coding with a 4-ary alphabet.

Whether a parameter is greater than one is determined (at 770).

In some implementations, the encoder determines that the prediction coding mode for the current block is a coding mode other than a compound, or bi-prediction, coding mode, and determining whether the parameter is greater than one includes using the shell index as the parameter.

In some implementations, the parameter may be less than or equal to one (1) and obtaining the distance value (at 780) and obtaining the encoded distance value (at 785), may be omitted or excluded for the current block, as indicated by the directional line labeled “NO” from determining whether the parameter is greater than one (at 770) to outputting the encoded bitstream (at 730).

In some implementations, the parameter is greater than one (1).

A distance value, or distance value data, is obtained (at 780). For example, the distance value may be obtained in response to a determination that the parameter is greater than one. Obtaining the distance value (m), which is an n-ary symbol in a range ([0, n−1]) from zero to one less than the shell index (n), includes obtaining, as the distance value (m), a result of subtracting a result of the quadrant value modulo two (mod (q, 2)), which may be equivalently expressed as a remainder of dividing the quadrant value by two, from the absolute value of the vertical component (|i_{y}|) of the motion vector difference, which may be expressed as the following:

$$m = \vert {i}_{y} \vert - mod ( q , 2 ) .$$

In some implementations, the quadrant value (q) is zero or two and the distance value (m) is the absolute value of the vertical component (|i_{y}|) of the motion vector difference (m=|i_{y}|), which is an n-ary symbol in a range ([0, n−1]) from zero to one less than the shell index (n).

In some implementations, the quadrant value (q) is other than zero or two and the distance value (m) is one less than the absolute value of the vertical component (|i_{y}|) of the motion vector difference of the motion vector difference (m=|i_{y}|−1), which is an n-ary symbol in a range ([0, n−1]) from zero to one less than the shell index (n).

An encoded distance value, or encoded distance value data, is obtained (at 785). In some implementations, the encoded distance value is obtained by encoding the distance value using quasi-uniform coding, such as using a quasi-uniform code including a three-bit part and a two-bit part, using an n-ary alphabet having a size of the shell index (n).

Values of the distance value (m) that are relatively close to zero correspond with relatively horizontal motion vector differences and values of the distance value (m) that are relatively close to one less than the shell index (n) correspond with relatively vertical motion vector differences, such that adaptive entropy coding of the distance value (m) may improve coding efficiency. Adaptive entropy coding of the distance value (m) includes dividing the range ([0, n−1]) for the distance value (m) into a defined cardinality (R) of range-classes, determining a range-class identifier of a range-class from the range-classes in accordance with the distance value, adaptive entropy coding the range-class identifier, and quasi-uniform coding an index of the distance value within the range-class.

The output, compressed, or encoded, bitstream, including the encoded block data, is output (at 730). Outputting the encoded bitstream includes including the encoded motion vector difference data, including the encoded shell index, the encoded quadrant value, the encoded distance value, or a combination thereof, in the encoded bitstream.

Although not shown expressly in FIG. 7, in some implementations, encoding using pyramid lattice vector quantization for coding motion vector differences 700 includes obtaining, or determining, that the prediction coding mode for the current block is compound prediction, or bi-prediction, wherein the current block is encoded using a first motion vector and a second motion vector, which includes obtaining a first predicted motion vector for the current block, obtaining a second predicted motion vector for the current block, obtaining the first motion vector for the current block, obtaining the second motion vector for the current block, obtaining encoded block data by encoding the current block using the first motion vector and the second motion vector, and including the encoded block data in an encoded, or output, bitstream.

In some implementations, the encoder determines that the prediction coding mode for the current block is compound prediction, or bi-prediction, and obtaining the motion vector difference (at 720) includes obtaining the motion vector difference MVD {iₓ, i_{y}}, as a first motion vector difference, for the first motion vector by subtracting the first predicted motion vector from the first motion vector used to encode the current block, and obtaining a second motion vector difference MVD {jₓ, j_{y}} for the second motion vector by subtracting the second predicted motion vector from the second motion vector used to encode the current block.

In some implementations, the encoder determines that the prediction coding mode for the current block is compound, or bi-prediction, and obtaining the encoded motion vector difference data (at 725) includes determining whether to obtain encoded motion vector difference data for the first motion vector difference MVD {iₓ, i_{y}} and the second motion vector difference MVD {jₓ, j_{y}} jointly ({iₓ, i_{y}, jₓ, j_{y}}) or independently ({iₓ, i_{y}}, {jₓ, j_{y}}), wherein obtaining the encoded motion vector difference data independently includes obtaining first encoded motion vector difference data for the first motion vector difference MVD {iₓ, i_{y}} independently of the second motion vector difference MVD {jₓ, j_{y}}, and obtaining second encoded motion vector difference data for the second motion vector difference MVD {jₓ, j_{y}} independently of the first motion vector difference MVD {iₓ, i_{y}}.

In some implementations, the encoder determines to encode the motion vector differences independently ({iₓ, i_{y}}, {jₓ, j_{y}}), and obtaining the encoded motion vector difference data (at 725) includes encoding the motion vector difference MVD {iₓ, i_{y}} as described as the first motion vector difference and encoding the second motion vector difference MVD {jₓ, j_{y}}, as indicated by the broken directional line at 790.

Encoding the second motion vector difference MVD {jₓ, j_{y}} is similar to encoding the motion vector difference MVD {iₓ, i_{y}} as described, except as is described herein or as is otherwise clear from context. Encoding the second motion vector difference MVD {jₓ, j_{y}} includes obtaining second encoded motion vector difference data (at 725), which includes obtaining a second shell index (at 740) for encoding the second motion vector difference MVD {jₓ, j_{y}}, obtaining a second encoded shell index (at 745) for encoding the second motion vector difference MVD {jₓ, j_{y}}, determining whether the second shell index is greater than zero (at 750) for encoding the second motion vector difference MVD {jₓ, j_{y}}, obtaining a second quadrant value (at 760) for encoding the second motion vector difference MVD {jₓ, j_{y}}, obtaining a second encoded quadrant value (at 765) for encoding the second motion vector difference MVD {jₓ, j_{y}}, determining whether a second parameter is greater than one (at 770) for encoding the second motion vector difference MVD {jₓ, j_{y}}, obtaining a second distance value (at 780) for encoding the second motion vector difference MVD {jₓ, j_{y}}, and obtaining a second encoded distance value (at 785) for encoding the second motion vector difference MVD {jₓ, j_{y}}.

Encoding the second motion vector difference MVD {jₓ, j_{y}} includes determining (at 740) a second shell index (n₁) as a sum of an absolute value of a horizontal component of the second motion vector difference and an absolute value of a vertical component of the second motion vector difference.

Encoding the second motion vector difference MVD {jₓ, j_{y}} includes encoding (at 745) the second shell index (n₁). Encoding the second shell index includes using a Rice-Golomb coder, an Exp-Golomb coder, or a multiclass adaptive entropy coder.

Encoding the second motion vector difference MVD {jₓ, j_{y}} includes, in response to a determination that the second shell index (n₁) is greater than zero (at 750), determining (at 760) a second quadrant value (q₁) in accordance with the second motion vector difference MVD {jₓ, j_{y}}, and encoding (at 765) the second quadrant value (q₁) using adaptive entropy coding using the alphabet having the size of four.

Encoding the second motion vector difference MVD {jₓ, j_{y}} includes using the second shell index (n₁) as a second parameter and, in response to a determination (at 770) that the second parameter is greater than one, determining (at 780), as a second distance value (m₁), a result of subtracting a result of the second quadrant value (q₁) modulo two, which may be equivalently expressed as a remainder of dividing the second quadrant value by two, from the absolute value of the vertical component (j_{y}) of the second motion vector difference MVD {jₓ, j_{y}}, and encoding (at 785) the second distance value (m₁) using quasi-uniform coding using an alphabet having a size of the second shell index (n₁).

Outputting the encoded bitstream (at 730) includes including the second encoded motion vector difference data, including the second encoded shell index, the second encoded quadrant value, the second encoded distance value, or a combination thereof, in the encoded bitstream.

In some implementations, the encoder determines that the prediction coding mode for the current block is compound prediction, or bi-prediction, and determines to encode the motion vector differences jointly ({iₓ, i_{y}, jₓ, j_{y}}). Encoding the motion vector differences jointly ({iₓ, i_{y}, jₓ, j_{y}}) is similar to encoding the motion vector difference MVD {iₓ, i_{y}} as described, except as is described herein or as is otherwise clear from context.

Encoding the motion vector differences jointly ({iₓ, i_{y}, jₓ, j_{y}}) includes obtaining encoded motion vector difference data (at 725) for the first motion vector difference MVD {iₓ, i_{y}} and for the second motion vector difference MVD {jₓ, j_{y}}, which includes obtaining a first shell index (at 740), obtaining a first encoded shell index (at 745), determining whether the first shell index is greater than zero (at 750), obtaining a second shell index (at 740), and obtaining a second encoded shell index (at 745), as indicated by the broken directional line (at 755) from determining whether the first shell index is greater than zero (at 750) to obtaining a second shell index (at 740).

For encoding the motion vector differences jointly ({iₓ, i_{y}, jₓ, j_{y}}), the encoder obtains (at 740), as the shell index (n) (first shell index), a sum of the absolute value of the horizontal component of the (first) motion vector difference, the absolute value of the (first) vertical component of the motion vector difference, the absolute value of the horizontal component of the second motion vector difference, and the absolute value of the vertical component of the second motion vector difference, which may be expressed as the following:

$$n = \vert {i}_{x} \vert + \vert {i}_{y} \vert + \vert {j}_{x} \vert + \vert {j}_{y} \vert .$$

For encoding the motion vector differences jointly ({iₓ, i_{y}, jₓ, j_{y}}), the encoder obtains first encoded shell index data by encoding the first shell index (n) (at 745) as described. In some implementations, encoding the first shell index (n) includes encoding the first shell index (n) using a Rice-Golomb coder, an Exp-Golomb coder, or a multiclass adaptive entropy coder. In some implementations, encoding the first shell index (n) includes encoding the first shell index (n) includes class-based shell index coding, wherein coding the first shell index (n), other than using class-based shell index coding, is omitted.

Encoding the motion vector differences jointly ({iₓ, i_{y}, jₓ, j_{y}}) includes determining whether the first shell index (n) is greater than zero (at 750). In some implementations, the first shell index (n) is greater than zero. In some implementations, the first shell index (n) is zero and obtaining a second shell index (at 740) and obtaining a second encoded shell index (at 745) is otherwise omitted or excluded for the current block, as indicated by the directional line labeled “NO” from determining whether the shell index (n) is greater than zero (at 750) to outputting the encoded bitstream (at 730).

For encoding the motion vector differences jointly ({iₓ, i_{y}, jₓ, j_{y}}), the encoder, in response to the determination (at 750) that the first shell index (n) is greater than zero as described, obtains a second shell index (n₁) as a sum of the absolute value of the horizontal component of the motion vector difference and the absolute value of the vertical component of the motion vector difference, as indicated by the broken directional line (at 755) from determining whether the first shell index is greater than zero (at 750) to obtaining a second shell index (at 740).

For encoding the motion vector differences jointly ({iₓ, i_{y}, jₓ, j_{y}}), the encoder encodes (at 745) the second shell index (n₁) using an alphabet having a size of a result of adding one to the shell index (n).

Obtaining encoded motion vector difference data (at 725) for encoding the first motion vector difference MVD {iₓ, i_{y}} and the second motion vector difference MVD {jₓ, j_{y}} jointly ({iₓ, i_{y}, jₓ, j_{y}}) includes obtaining first encoded motion vector difference data based on the first the first motion vector difference MVD {iₓ, i_{y}} and the second shell index (n₁), which includes obtaining a first quadrant value (at 760), obtaining a first encoded quadrant value (at 765), determining whether a first parameter is greater than one (at 770), obtaining a first distance value (at 780), and obtaining a first encoded distance value (at 785).

For encoding the motion vector differences jointly ({iₓ, i_{y}, jₓ, j_{y}}), obtaining the first encoded motion vector difference data based on the first the first motion vector difference MVD {iₓ, i_{y}} and the second shell index (n₁) includes obtaining the first quadrant value (at 760) as described. The first quadrant value (q), which is a 4-ary symbol in a range from zero to three ([0,3]) indicates a quadrant in which the first motion vector difference (MVD {iₓ, i_{y}}) results.

For encoding the motion vector differences jointly ({iₓ, i_{y}, jₓ, j_{y}}), obtaining the first encoded motion vector difference data based on the first the first motion vector difference MVD {iₓ, i_{y}} and the second shell index (n₁) includes obtaining the first encoded quadrant value (at 765) as described. The first quadrant value (q) may be encoded using adaptive entropy coding with a 4-ary alphabet.

For encoding the motion vector differences jointly ({iₓ, i_{y}, jₓ, j_{y}}), obtaining the first encoded motion vector difference data based on the first the first motion vector difference MVD {iₓ, i_{y}} and the second shell index (n₁) includes determining whether the parameter is greater than one (at 770) using the second shell index (n₁) as the parameter, wherein using the first shell index (n) as the parameter is omitted.

In some implementations, the parameter may be less than or equal to one (1) and obtaining the distance value (at 780) and obtaining the encoded distance value (at 785), may be omitted or excluded for obtaining the first encoded motion vector difference data based on the first the first motion vector difference MVD {iₓ, i_{y}} and the second shell index (n₁), as indicated by the directional line labeled “NO” from determining whether the parameter is greater than one (at 770) to obtaining a second quadrant value (at 760).

In some implementations, the parameter is greater than one (1).

For encoding the motion vector differences jointly ({iₓ, i_{y}, jₓ, j_{y}}), obtaining the first encoded motion vector difference data based on the first the first motion vector difference MVD {iₓ, i_{y}} and the second shell index (n₁) includes obtaining, such as in response to determining that the parameter is greater than one, a first distance value (at 780) as described. The first distance value (m) is an n₁-ary symbol in a range ([0, n₁−1]) from zero to one less than the second shell index (n₁).

For encoding the motion vector differences jointly ({iₓ, i_{y}, jₓ, j_{y}}), obtaining the first encoded motion vector difference data based on the first the first motion vector difference MVD {iₓ, i_{y}} and the second shell index (n₁) includes obtaining a first encoded distance value (at 785).

In some implementations, the first encoded distance value is obtained by encoding the first distance value using quasi-uniform coding, such as using a quasi-uniform code including a three-bit part and a two-bit part, using an n₁-ary alphabet having a size of the second shell index (n₁).

Obtaining encoded motion vector difference data (at 725) for encoding the first motion vector difference MVD {iₓ, i_{y}} and for the second motion vector difference MVD {jₓ, j_{y}} jointly ({iₓ, i_{y}, jₓ, j_{y}}) includes obtaining second encoded motion vector difference data based on the first the second motion vector difference MVD {jₓ, j_{y}}, the first shell index (n), and the second shell index (n₁), which includes obtaining a second quadrant value (at 760), obtaining a second encoded quadrant value (at 765), determining whether a second parameter is greater than one (at 770), obtaining a second distance value (at 780), and obtaining a second encoded distance value (at 785), as indicated by the broken directional line (at 795) from obtaining a first encoded distance value (at 785) to obtaining a second quadrant value (at 760). A determination whether the second shell index is greater than zero may be omitted.

For encoding the motion vector differences jointly ({iₓ, i_{y}, jₓ, j_{y}}), obtaining the second encoded motion vector difference data based on the first the second motion vector difference MVD {jₓ, j_{y}}, the first shell index (n), and the second shell index (n₁) includes obtaining the second quadrant value (at 760). The second quadrant value (q), which is a 4-ary symbol in a range from zero to three ([0,3]) indicates a quadrant in which the second motion vector difference (MVD {jₓ, j_{y}}) results. Obtaining the second quadrant value (q) is similar to obtaining the first quadrant value, except as is described herein or as is otherwise clear from context.

For encoding the motion vector differences jointly ({iₓ, i_{y}, jₓ, j_{y}}), obtaining the second encoded motion vector difference data based on the first the second motion vector difference MVD {jₓ, j_{y}}, the first shell index (n), and the second shell index (n₁) includes obtaining the second encoded quadrant value (at 765) as described. The second quadrant value (q) may be encoded using adaptive entropy coding with a 4-ary alphabet.

For encoding the motion vector differences jointly ({iₓ, i_{y}, jₓ, j_{y}}), obtaining the second encoded motion vector difference data based on the first the second motion vector difference MVD {jₓ, j_{y}}, the first shell index (n), and the second shell index (n₁) includes determining whether the parameter is greater than one (at 770) using a result of subtracting the second shell index (n₁) from the first shell index (n) as the parameter.

In some implementations, the parameter may be less than or equal to one (1) and obtaining the distance value (at 780) and obtaining the encoded distance value (at 785), may be omitted or excluded for obtaining the second encoded motion vector difference data based on the first the second motion vector difference MVD {jₓ, j_{y}}, the first shell index (n), and the second shell index (n₁), as indicated by the directional line labeled “NO” from determining whether the parameter is greater than one (at 770) to outputting the encoded bitstream (at 730).

In some implementations, the parameter is greater than one (1).

For encoding the motion vector differences jointly ({iₓ, i_{y}, jₓ, j_{y}}), obtaining the second encoded motion vector difference data based on the first the second motion vector difference MVD {jₓ, j_{y}}, the first shell index (n), and the second shell index (n₁) includes obtaining, such as in response to determining that the parameter is greater than one, a second distance value (at 780) as described. The second distance value (m) is an n−n₁-ary symbol in a range ([0, n−n₁−1]) from zero to one less than the result of subtracting the second shell index (n₁) from the first shell index (n) (n-n₁).

For encoding the motion vector differences jointly ({iₓ, i_{y}, jₓ, j_{y}}), obtaining the second encoded motion vector difference data based on the first the second motion vector difference MVD {jₓ, j_{y}}, the first shell index (n), and the second shell index (n₁) includes obtaining a second encoded distance value (at 785).

In some implementations, the second encoded distance value is obtained by encoding the second distance value using quasi-uniform coding, such as using a quasi-uniform code including a three-bit part and a two-bit part, using an n−n₁-ary alphabet having a size of the result of subtracting the second shell index (n₁) from the first shell index (n) (n-n₁).

The output, compressed, or encoded, bitstream, including the encoded block data, is output (at 730). Outputting the encoded bitstream includes including the first encoded motion vector difference data and the second encoded motion vector difference data, including the first encoded shell index, the first encoded quadrant value, the first encoded distance value, the second encoded shell index, the second encoded quadrant value, the second encoded distance value, or a combination thereof, in the encoded bitstream.

Encoding using pyramid lattice vector quantization for coding motion vector differences 700 may include using companding, adaptive motion vector difference precision, flexible motion vector difference precision, or a combination thereof, which may improve coding efficiency and reduce resource, such as bandwidth, utilization. For example, encoding using pyramid lattice vector quantization for coding motion vector differences 700 may include using companding, such that precision may be reduced, such as for relatively high magnitude motion vector differences, and adaptive, or flexible, motion vector difference precision.

The shell index (nₚ) of a motion vector difference at a precision (p). A precision of zero (p=0) corresponds to a highest, or maximum, precision. An increase in the precision (p) corresponds to a dyadic increase in coarseness of precision. The motion vector difference may be in one of multiple disjoint companding zones. A respective companding zone (z) (z>=0) is described using a corresponding shell index at a highest precision with power of two boundaries. A respective companding zone (z) may be associated with one or more available precisions, wherein the available precisions for a companding zone (z) may differ from the available precisions for another companding zone (z). A companding zone (z) may be similar to, or equivalent to, a shell class, except as is described herein or as is otherwise clear from context. Whether a motion vector difference belongs to a respective companding zone, wherein an increasing array (u(z)) having a cardinality, or number, of elements that is the cardinality, or number, of companding zones, indicating an upper limit, such as a log 2 of the upper limit, for a zone (z), may be expressed as the following:

$$\{ {2}^{u ( z - 1 )} for z > 0 , or 0 for z = 0 \} <= {n}_{0} < {2}^{u ( z )} .$$

At a precision p (0 being the finest precision), the equivalent zone delimiters may be expressed as the following:

$$\{ {2}^{u ( z - 1 ) - p} for z > 0 , or 0 for z = 0 \} <= {n}_{p} < {2}^{u ( z ) - p} .$$

Encoding using pyramid lattice vector quantization for coding motion vector differences 700 including using companding and flexible motion vector difference precision includes coding a companding zone index (z) of a motion vector difference at a precision (p), wherein the zone index (z) indicates a set of available precisions for the vector, from which the precision (p) is coded.

The shell index at the indicated precision (p) and within the companding zone (z) is signaled.

Encoding using pyramid lattice vector quantization for coding motion vector differences 700 including using companding and flexible motion vector difference precision at precision (p) includes determining whether the shell index is greater than zero (at 750), obtaining a quadrant value (at 760), obtaining an encoded quadrant value (at 765), determining whether a parameter is greater than one (at 770), obtaining a distance value (at 780), and obtaining an encoded distance value (at 785).

Encoding using pyramid lattice vector quantization for coding motion vector differences 700 including using companding and flexible motion vector difference precision avoids overheads in signaling of the shell index and improves efficiency.

For a scalar based coding scheme where the horizontal (x) and vertical (y) components are addressed separately, a square shell-based scheme where the shell index is replaced by the maximum magnitude of horizontal (x) and vertical (y) components of the motion vector difference may be used.

A broken directional line between output (at 730) and obtaining the current block (at 710) is shown (at 735) to indicate that obtaining a current block (at 710), obtaining a motion vector difference (at 720), obtaining encoded motion vector difference data (at 725), and outputting the encoded bitstream (at 730), or a combination thereof, may be performed on a per-block basis for the current frame.

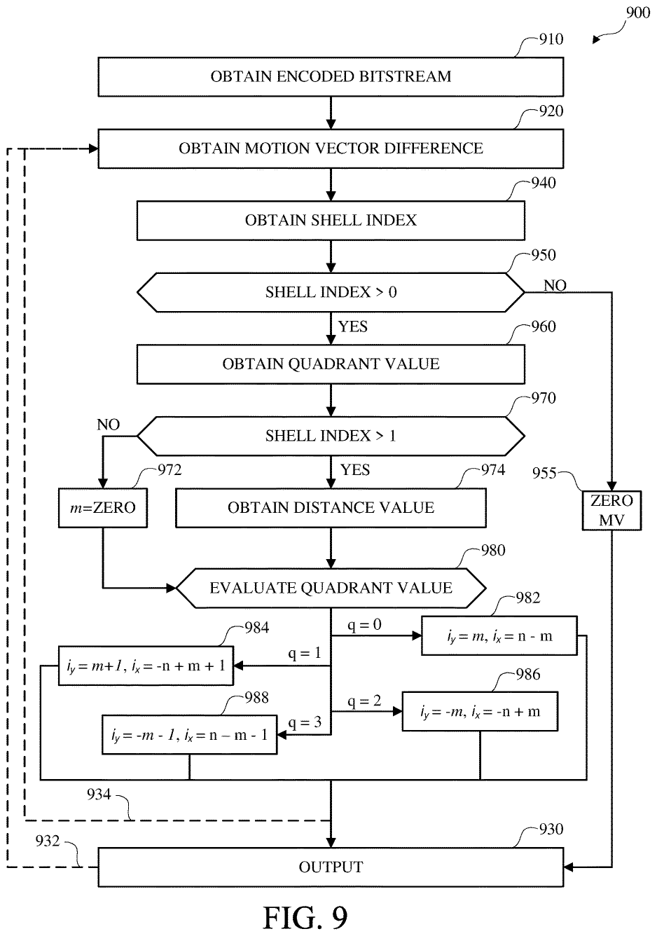

FIG. 8 is a block diagram of an example of pyramidal shells and quadrants 800, such as for encoding using pyramid lattice vector quantization for coding motion vector differences, such as the encoding using pyramid lattice vector quantization for coding motion vector differences 700 shown in FIG. 7 or the decoding using pyramid lattice vector quantization for coding motion vector differences 900 shown in FIG. 9.

A motion vector difference MVD {iₓ, i_{y}}, such as an integer motion vector difference MVD {iₓ, i_{y}}, may be represented using successive concentric pyramidal shells Sn indexed by a shell distance parameter n. For a motion vector difference MVD {iₓ, i_{y}}, such as an integer motion vector difference MVD {iₓ, i_{y}}, that is an element of (E) the successive concentric pyramidal shells Sn, the shell index (n) is a sum of an absolute value of a horizontal component (|iₓ|) of the motion vector difference and an absolute value of a vertical component (|i_{y}|) of the motion vector difference, which may be expressed as the following:

$$n = \vert {i}_{x} \vert + \vert {i}_{y} \vert .$$

The number, of cardinality, of motion vector differences, such as integer motion vector differences, in a shell (n), such as the successive concentric pyramidal shells Sn, may be expressed as the following:

$$\vert {S}_{n} \vert = 4 n , for n > 0 ; and$$

$$\vert {S}_{n} \vert = 1 , for n = 0.$$

In some implementations, the horizontal component (|iₓ|) of the motion vector difference and the vertical component (|i_{y}|) of the motion vector difference have marginal Laplacian distribution and pyramid lattice vector quantization is optimal.

FIG. 8 shows a first shell 810 having a shell index of one (n=1), a second shell 820 having a shell index of two (n=2), a third shell 830 having a shell index of three (n=3), a fourth shell 840 having a shell index of four (n=4), a fifth shell 850 having a shell index of five (n=5), a sixth shell 860 having a shell index of six (n=6), a seventh shell 870 having a shell index of seven (n=7), and an eighth shell 880 having a shell index of eight (n=8). Although eight shells are shown for simplicity, other numbers, or cardinalities, of shells may be used.

FIG. 8 shows four quadrants, including a first quadrant (q=0) at the top right, a second quadrant (q=1) at the top left, a third quadrant (q=2) at the bottom left, and a fourth quadrant (q=3) at the bottom right.

FIG. 8 shows available distance values (m) for the eighth shell 880 having the shell index of eight (n=8) as integer values in the range from zero to seven ([0-7]), wherein the available distance values (m) are shown as positioned near the corner of a respective small broken line square that intersects the eighth shell 880.

Locations having the vertical Cartesian value greater than or equal to zero (Y>=0) and a horizontal Cartesian value greater than zero (X>=0) are included in the first quadrant (q=0) at the top right. For example, a point corresponding to a horizontal Cartesian value of eight (X=8) and a vertical Cartesian value of zero (Y=0) has a distance value (m) of zero (m=0) in the first quadrant (q=0) at the top right and the eighth shell 880 having the shell index of eight (n=8). In another example, a point corresponding to a horizontal Cartesian value of one (X=1) and a vertical Cartesian value of seven (Y=7) has a distance value (m) of seven (m=7) in the first quadrant (q=0) at the top right and the eighth shell 880 having the shell index of eight (n=8).

Locations having the vertical Cartesian value greater than zero (Y=0) and a horizontal Cartesian value less than or equal to zero (X<=0) are included in the second quadrant (q=1) at the top left. For example, a point corresponding to a horizontal Cartesian value of zero (X=0) and a vertical Cartesian value of eight (Y=8) has a distance value (m) of seven (m=7) in the second quadrant (q=1) at the top left and the eighth shell 880 having the shell index of eight (n=8). In another example, a point corresponding to a horizontal Cartesian value of negative seven (X=−7) and a vertical Cartesian value of one (Y=1) has a distance value (m) of zero (m=0) in the second quadrant (q=1) at the top left and the eighth shell 880 having the shell index of eight (n=8).

Locations having the vertical Cartesian value less than or equal to zero (Y<=0) and a horizontal Cartesian value less than zero (X<0) are included in the third quadrant (q=2) at the bottom left. For example, a point corresponding to a horizontal Cartesian value of negative eight (X=−8) and a vertical Cartesian value of zero (Y=0) has a distance value (m) of zero (m=0) in the third quadrant (q=2) at the bottom left and the eighth shell 880 having the shell index of eight (n=8). In another example, a point corresponding to a horizontal Cartesian value of negative one (X=−1) and a vertical Cartesian value of negative seven (Y=−7) has a distance value (m) of seven (m=7) in the third quadrant (q=2) at the bottom left and the eighth shell 880 having the shell index of eight (n=8).

Locations having the vertical Cartesian value less than zero (Y<0) and a horizontal Cartesian value greater than or equal to zero (X>0) are included in the fourth quadrant (q=3) at the bottom right. For example, a point corresponding to a horizontal Cartesian value of zero (X=0) and a vertical Cartesian value of negative eight (Y=−8) has a distance value (m) of seven (m=7) in the fourth quadrant (q=3) at the bottom right and the eighth shell 880 having the shell index of eight (n=8). In another example, a point corresponding to a horizontal Cartesian value of seven (X=7) and a vertical Cartesian value of negative one (Y=−1) has a distance value (m) of zero (m=0) in the fourth quadrant (q=3) at the bottom right and the eighth shell 880 having the shell index of eight (n=8).

FIG. 9 is a flowchart diagram of an example of decoding using pyramid lattice vector quantization for coding motion vector differences 900 in accordance with implementations of this disclosure. Decoding using pyramid lattice vector quantization for coding motion vector differences 900 may be implemented in a decoder, such as the decoder 500 shown in FIG. 5.

Decoding using pyramid lattice vector quantization for coding motion vector differences 900 includes decoding an encoded bitstream, such as the compressed bitstream 502 shown in FIG. 5, or one or more portions thereof, to generate a reconstructed video, or a portion thereof, such as the output video stream 504 shown in FIG. 5.

Decoding using pyramid lattice vector quantization for coding motion vector differences 900 includes obtaining the encoded bitstream (at 910), obtaining a motion vector difference MVD {iₓ, i_{y}} for decoding the current block (at 920), and outputting an output bitstream (at 930).

The encoded bitstream is obtained (at 910). Obtaining the encoded bitstream includes identifying a current frame to decode from the encoded bitstream to generate a current reconstructed frame, which includes identifying a current block from the current frame to decode from the encoded bitstream to generate a current reconstructed block (reconstructed block data) to include in the current reconstructed frame. For example, the decoder, or a component thereof, such as an intra/inter prediction unit of the decoder, such as the entropy decoding unit 510 shown in FIG. 5, may obtain the input video stream. The current frame may be obtained (at 910) subsequent to decoding one or more other frames, such as a frame sequentially preceding the current frame, and generating, or otherwise obtaining, a corresponding reconstructed frame (or frames), or one or more portions thereof, for use as a reference frame (or frames) for decoding the current frame. Although not shown separately in FIG. 9, decoding using pyramid lattice vector quantization for coding motion vector differences 900 may include decoding, reconstructing, or both, one or more portions of the current frame prior to decoding, reconstructing, or both, the current block.

A motion vector difference MVD {iₓ, i_{y}}, which is a decoded, or reconstructed, motion vector difference MVD {iₓ, i_{y}}, for decoding the current block is obtained (at 920). Obtaining the motion vector difference MVD {iₓ, i_{y}} for decoding the current block (at 920) includes obtaining a shell index (at 940). Obtaining the shell index (n) includes decoding the shell index (n) from the encoded bitstream. In some implementations, decoding the shell index (n) includes decoding the shell index (n) using a Rice-Golomb coder, an Exp-Golomb coder, or a multiclass adaptive entropy coder.

In some implementations, decoding the shell index (n) includes decoding the shell index (n) includes class-based shell index coding (using adaptive entropy coding), wherein coding the shell index (n), other than using class-based shell index coding, is omitted. Decoding the shell index (n) using class-based shell index coding includes decoding, from the encoded bitstream, a shell class index (shell_class_idx). Decoding the shell index (n) using class-based shell index coding includes determining whether the shell class index (shell_class_idx) is greater than two (shell_class_idx>2).

In some implementations, the shell class index (shell_class_idx) is greater than two (shell_class_idx>2) and decoding the shell index (n) using class-based shell index coding includes decoding, from the encoded bitstream, a shell offset index (shell_offset_index).

In some implementations, the shell class index (shell_class_idx) is less than or equal to two (shell_class_idx<=2) and decoding the shell index (n) using class-based shell index coding includes using a value of zero as the shell offset index (shell_offset_index). Decoding the shell index (n) using class-based shell index coding includes obtaining a base value base value (base_value), which is a minimum shell index (n) in the respective shell class. To obtain the base value (base_value), the decoder may determine whether the shell class index (shell_class_idx) is less than two, and, in response to a determination that the shell class index is less than two, the decoder uses the shell class index (shell_class_idx) as the corresponding base value (base_value). In response to a determination that the shell class index (shell_class_idx) is at least, such as greater than or equal to, two (2), the decoder uses, as the corresponding base value (base_value) for the shell class index (shell_class_idx), a result of adding one to a result of left shifting one by a result of subtracting two from the shell class index (shell_class_idx), which may be expressed as the following:

$$base\_value = ( shell\_class \_idx < 2 ) ? shell\_class \_idx : 1 + 1 ≪ ( shell\_clas \_idx - 2 ) .$$

The decoder obtains, as the shell index (n), a sum of the base value (base_value) and the shell offset index (shell_offset_index).

Obtaining the motion vector difference MVD {iₓ, i_{y}} for decoding the current block (at 920) includes determining whether the shell index (n) is greater than zero (at 950).

In some implementations, the shell index (n) is greater than zero.

In some implementations, the shell index (n) is zero, a zero motion vector, which is a motion vector representing zero motion, such as having a horizontal component of zero and a vertical component of zero, is identified as the motion vector difference MVD {iₓ, i_{y}} for decoding the current block (at 955), and obtaining the decoded motion vector difference MVD {iₓ, i_{y}} is otherwise omitted or excluded for the current block, as indicated by the directional line labeled “NO” from determining whether the shell index (n) is greater than zero (at 950) to zero MV (at 955) and from zero MV (at 955) to output (at 930).

A quadrant value, or quadrant value data, is obtained (at 960). For example, as shown in FIG. 9, the quadrant value (q) is obtained (at 960) in response to a determination that the shell index (n) is greater than zero (at 950). Obtaining the quadrant value (q) includes obtaining the quadrant value (q) by decoding the quadrant value (q) from the encoded bitstream.

Obtaining the motion vector difference MVD {iₓ, i_{y}} for decoding the current block (at 920) includes determining whether the shell index (n) is greater than one (at 970).

In some implementations, the shell index (n) is less than or equal to one (1), obtaining the motion vector difference MVD {iₓ, i_{y}} for decoding the current block includes obtaining distance value (m) of zero (at 972), and obtaining the distance value (at 974) is otherwise omitted or excluded for the current block, as indicated by the directional line labeled “NO” from determining whether the shell index (n) is greater than one (at 970) to evaluating the quadrant value (at 980).

In some implementations, the shell index (n) is greater than one (1) and obtaining the motion vector difference MVD {iₓ, i_{y}} for decoding the current block includes obtaining distance value (m), which is an n-ary symbol in a range ([0, n−1]) from zero to one less than the shell index (n), by decoding the distance value (m) from the encoded bitstream (at 974), such as using quasi-uniform coding, such as using a quasi-uniform code including a three-bit part and a two-bit part, using an n-ary alphabet having a size of the shell index (n).

Obtaining the motion vector difference MVD {iₓ, i_{y}} for decoding the current block includes evaluating (at 980) the quadrant value (q) (obtained at 960).

In some implementations, evaluating the quadrant value (q) includes determining (at 980) that the quadrant value (q) is zero (q=0) and obtaining the motion vector difference MVD {iₓ, i_{y}} for decoding the current block includes obtaining (at 982) the distance value (m) as the vertical component (i_{y}) of the motion vector difference MVD {iₓ, i_{y}} (i_{y}=m) and obtaining (at 982), as the horizontal component (iₓ) of the motion vector difference MVD {iₓ, i_{y}}, a result of subtracting the distance value (m) from the shell index (n) (iₓ=n−m).

In some implementations, evaluating the quadrant value (q) includes determining (at 980) that the quadrant value (q) is one (q=1) and obtaining the motion vector difference MVD {iₓ, i_{y}} for decoding the current block includes obtaining (at 984) a sum of one and the distance value (m) as the vertical component (iv) of the motion vector difference MVD {iₓ, i_{y}} (i_{y}=m+1) and obtaining (at 984), as the horizontal component (iₓ) motion vector difference MVD {iₓ, i_{y}}, a sum of one, the distance value (m), and an additive inverse of the shell index (n) (iₓ=−n+m+1).

In some implementations, evaluating the quadrant value (q) includes determining (at 980) that the quadrant value (q) is two (q=2) and obtaining the motion vector difference MVD {iₓ, i_{y}} for decoding the current block includes obtaining (at 986) an additive inverse of the distance value (m) as the vertical component (i_{y}) of the motion vector difference MVD {iₓ, i_{y}} (i_{y}=−m) and obtaining (at 986), as the horizontal component (iₓ) of the motion vector difference MVD {iₓ, i_{y}}, a sum of the distance value (m) and an additive inverse of the shell index (n) (iₓ=−n+m).

In some implementations, evaluating the quadrant value (q) includes determining (at 980) that the quadrant value (q) is three (q=3) and obtaining the motion vector difference MVD {iₓ, i_{y}} for decoding the current block includes obtaining (at 988) a result of subtracting one from the additive inverse of the distance value (m) as the vertical component (i_{y}) of the motion vector difference MVD {iₓ, i_{y}} (i_{y}=−m−1) and obtaining (at 988), as the horizontal component (iₓ) of the motion vector difference MVD {iₓ, i_{y}}, a result of subtracting one from a result of subtracting the distance value (m) from the shell index (n) (iₓ=n−m−1).

Although not expressly shown in FIG. 9, decoding using pyramid lattice vector quantization for coding motion vector differences 900 includes obtaining a motion vector predictor for decoding the current block, obtaining the motion vector for decoding the current block by combining, such as by adding, the motion vector predictor and the motion vector difference MVD {iₓ, i_{y}}, obtaining decoded residual data, such as by decoding encoded residual data from the encoded bitstream, obtaining a prediction block in accordance with the motion vector, and obtaining a reconstructed block by combining the prediction block and the decoded residual data. The reconstructed block data for the current block is included in reconstructed frame data for the current frame, which is included in an output video stream, such as the output video stream 504 shown in FIG. 5, which is output (at 980).

A broken directional line between output (at 930) and obtaining a decoded motion vector (at 920) is shown (at 932) to indicate that decoding using pyramid lattice vector quantization for coding motion vector differences 900 may be performed on a per-block basis for the blocks from the current frame.

Although not shown expressly in FIG. 9, in some implementations, decoding using pyramid lattice vector quantization for coding motion vector differences 900 includes obtaining, or determining, that the prediction coding mode for the current block is compound prediction, or bi-prediction, wherein the current block is encoded using a first motion vector and a second motion vector, which includes obtaining a first motion vector difference MVD {iₓ, i_{y}} for the current block, obtaining a second motion vector difference MVD {jₓ, j_{y}} for the current block, obtaining the motion vector for the current block as the first motion vector using the first motion vector difference MVD {iₓ, i_{y}}, obtaining the second motion vector for the current block using the second motion vector difference MVD {jₓ, j_{y}}, and obtaining the decoded block data by decoding the current block using the first motion vector and the second motion vector.

In some implementations, the prediction coding mode for the current block is compound prediction, or bi-prediction, and obtaining the motion vector difference (at 920) includes obtaining the motion vector difference MVD {iₓ, i_{y}} as the first motion vector difference, obtaining the first motion vector by adding a first predicted motion vector to the first motion vector difference MVD {iₓ, i_{y}}, obtaining a second motion vector difference MVD {jₓ, j_{y}}, and obtaining the second motion vector by adding a second predicted motion vector to the second motion vector difference MVD {jₓ, j_{y}}.

In some implementations, the decoder determines that the prediction coding mode for the current block is compound, or bi-prediction, and obtaining the motion vector difference MVD {iₓ, i_{y}} (at 920) includes determining whether the first motion vector difference MVD {iₓ, i_{y}} and the second motion vector difference MVD {jₓ, j_{y}} are encoded jointly ({iₓ, i_{y}, jₓ, j_{y}}) or independently ({iₓ, i_{y}}, {jₓ, j_{y}}).

In some implementations, the decoder determines the motion vector differences are encoded independently ({iₓ, i_{y}}, {jₓ, j_{y}}), and decoding using pyramid lattice vector quantization for coding motion vector differences 900 includes decoding the motion vector difference MVD {iₓ, i_{y}} as described as the first motion vector difference and decoding the second motion vector difference MVD {jₓ, j_{y}}, as indicated by the broken directional line at 934. Decoding the second motion vector difference MVD {jₓ, j_{y}} independently is similar to decoding the motion vector difference MVD {iₓ, i_{y}} as described, except as is described herein or as is otherwise clear from context.

A second motion vector difference MVD {jₓ, j_{y}}, which is a decoded, or reconstructed, second motion vector difference MVD {jₓ, j_{y}}, for decoding the current block is obtained (at 920). Obtaining the second motion vector difference MVD {jₓ, j_{y}} for decoding the current block (at 920) includes obtaining a second shell index (at 940).

Obtaining the second shell index (n₁) includes decoding the second shell index (n₁) from the encoded bitstream. In some implementations, decoding the second shell index (n₁) includes decoding the second shell index (n₁) using a Rice-Golomb coder, an Exp-Golomb coder, or a multiclass adaptive entropy coder. In some implementations, decoding the second shell index (n₁) includes decoding the second shell index (n₁) includes class-based shell index coding (using adaptive entropy coding), wherein coding the second shell index (n₁), other than using class-based shell index coding, is omitted.

Obtaining the second motion vector difference MVD {jₓ, j_{y}} for decoding the current block (at 920) includes determining whether the second shell index (n₁) is greater than zero (at 950).

In some implementations, the second shell index (n₁) is greater than zero.

In some implementations, the second shell index (n₁) is zero, a zero motion vector, which is a motion vector representing zero motion, such as having a horizontal component of zero and a vertical component of zero, is identified as the second motion vector difference MVD {jₓ, j_{y}} for decoding the current block (at 955), and obtaining the second motion vector difference MVD {jₓ, j_{y}} is otherwise omitted or excluded for the current block, as indicated by the directional line labeled “NO” from determining whether the second shell index (n₁) is greater than zero (at 950) to zero MV (at 955) and from zero MV (at 955) to output (at 930).

A second quadrant value, or second quadrant value data, is obtained (at 960). For example, as shown in FIG. 9, the second quadrant value (q) is obtained (at 960) in response to a determination that the second shell index (n₁) is greater than zero (at 950). Obtaining the second quadrant value (q) includes obtaining the second quadrant value (q) by decoding the second quadrant value (q) from the encoded bitstream.

Obtaining the second motion vector difference MVD {jₓ, j_{y}} for decoding the current block (at 920) includes determining whether the second shell index (n₁) is greater than one (at 970).

In some implementations, the second shell index (n₁) is less than or equal to one (1), obtaining the second motion vector difference MVD {jₓ, j_{y}} for decoding the current block includes obtaining a second distance value (m) of zero (at 972), and obtaining the second distance value (at 974) is otherwise omitted or excluded for the current block, as indicated by the directional line labeled “NO” from determining whether the second shell index (n₁) is greater than one (at 970) to evaluating the second quadrant value (at 980).

In some implementations, the second shell index (n₁) is greater than one (1) and obtaining the second motion vector difference MVD {jₓ, j_{y}} for decoding the current block includes obtaining the second distance value (m), which is an n-ary symbol in a range ([0, n−1]) from zero to one less than the second shell index (n₁), by decoding the second distance value (m) from the encoded bitstream (at 974), such as using quasi-uniform coding, such as using a quasi-uniform code including a three-bit part and a two-bit part, using an n-ary alphabet having a size of the second shell index (n₁).

Obtaining the second motion vector difference MVD {jₓ, j_{y}} for decoding the current block includes evaluating (at 980) the second quadrant value (q) (obtained at 960).

In some implementations, evaluating the second quadrant value (q) includes determining (at 980) that the second quadrant value (q) is zero (q=0) and obtaining the second motion vector difference MVD {jₓ, j_{y}} for decoding the current block includes obtaining (at 982) the second distance value (m) as the vertical component (j_{y}) of the second motion vector difference MVD {jₓ, j_{y}} (j_{y}=m) and obtaining (at 982), as the horizontal component (jₓ) of the second motion vector difference MVD {jₓ, j_{y}}, a result of subtracting the second distance value (m) from the second shell index (n₁) (jₓ=n₁−m).

In some implementations, evaluating the second quadrant value (q) includes determining (at 980) that the second quadrant value (q) is one (q=1) and obtaining the second motion vector difference MVD {jₓ, j_{y}} for decoding the current block includes obtaining (at 984) a sum of one and the second distance value (m) as the vertical component (j_{y}) of the second motion vector difference MVD {jₓ, j_{y}} (j_{y}=m+1) and obtaining (at 984), as the horizontal component (jₓ) of the second motion vector difference MVD {jₓ, j_{y}}, a sum of one, the second distance value (m), and an additive inverse of the second shell index (n₁) (jₓ=−n₁+m+1).

In some implementations, evaluating the second quadrant value (q) includes determining (at 980) that the second quadrant value (q) is two (q=2) and obtaining the second motion vector difference MVD {jₓ, j_{y}} for decoding the current block includes obtaining (at 986) an additive inverse of the second distance value (m) as the vertical component (j_{y}) of the second motion vector difference MVD {jₓ, j_{y}} (j_{y}=−m) and obtaining (at 986), as the horizontal component (jₓ) of the second motion vector difference MVD {jₓ, j_{y}}, a sum of the second distance value (m) and an additive inverse of the second shell index (n₁) (jₓ=−n₁+m).

In some implementations, evaluating the second quadrant value (q) includes determining (at 980) that the second quadrant value (q) is three (q=3) and obtaining the second motion vector difference MVD {jₓ, j_{y}} for decoding the current block includes obtaining (at 988) a result of subtracting one from the additive inverse of the second distance value (m) as the vertical component (j_{y}) of the second motion vector difference MVD {jₓ, j_{y}} (j_{y}=−m−1) and obtaining (at 988), as the horizontal component (jₓ) of the second motion vector difference MVD {jₓ, j_{y}}, a result of subtracting one from a result of subtracting the second distance value (m) from the second shell index (n₁) (jₓ=n₁−m−1).

In some implementations, the decoder determines that the prediction coding mode for the current block is compound prediction, or bi-prediction, and determines that the motion vector differences are encoded jointly ({iₓ, i_{y}, jₓ, j_{y}}). Decoding the motion vector differences jointly ({iₓ, i_{y}, jₓ, j_{y}}) is similar to decoding the motion vector differences independently ({iₓ, i_{y}}, {jₓ, j_{y}}) as described, except as is described herein or as is otherwise clear from context.

Decoding the motion vector differences jointly ({iₓ, i_{y}, jₓ, j_{y}}) includes decoding the second shell index (n₁) conditioned on the first shell index (n). For example, the second shell index (n₁) may be less than or equal to the first shell index (n) and the set of available values for the second shell index (n₁) may be restricted.

Decoding using pyramid lattice vector quantization for coding motion vector differences 900 may include using companding, adaptive motion vector difference precision, flexible motion vector difference precision, or a combination thereof, which may improve coding efficiency and reduce resource, such as bandwidth, utilization. For example, decoding using pyramid lattice vector quantization for coding motion vector differences 900 may include using companding, wherein precision is reduced for relatively high magnitude motion vector differences, and adaptive, or flexible, motion vector difference precision. Decoding using pyramid lattice vector quantization for coding motion vector differences 900 using companding, adaptive motion vector difference precision, flexible motion vector difference precision, or a combination thereof is similar to encoding using companding as described herein, except as is described herein or as is otherwise clear from context.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted from implementations of methods in accordance with the disclosed subject matter.

The implementations of the transmitting computing and communication device 100A and/or the receiving computing and communication device 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. In this instance, the transmitting computing and communication device 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting computing and communication device 100A. Other suitable transmitting computing and communication device 100A and receiving computing and communication device 100B implementation schemes are available. For example, the receiving computing and communication device 100B can be a generally stationary personal computer rather than a portable communications device and/or a device including an encoder 400 may also include a decoder 500.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g., disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above implementations have been described to allow easy understanding of the application are not limiting. On the contrary, the application covers various modifications and equivalent arrangements included within the scope of the appended claims, which scope is to be accorded the broadest interpretation to encompass all such modifications and equivalent structure as is permitted under the law.

1. A method comprising:
generating encoded block data by encoding a current block from a current frame from an input video stream, wherein encoding the current block includes:
obtaining a motion vector difference by subtracting a predicted motion vector from a motion vector used to encode the current block; and
encoding the motion vector difference by:
determining a shell index as a sum of an absolute value of a horizontal component of the motion vector difference and an absolute value of a vertical component of the motion vector difference;
obtaining an encoded shell index by encoding the shell index; and
in response to a determination that the shell index is greater than zero:
determining a quadrant value in accordance with the motion vector;
obtaining an encoded quadrant value by encoding the quadrant value using adaptive entropy coding using an alphabet having a size of four; and
in response to a determination that a parameter is greater than one, wherein the determination that the parameter is greater than one includes using the shell index as the parameter:
determining, as a distance value, a result of subtracting a remainder of dividing the quadrant value by two from the absolute value of the vertical component of the motion vector difference; and
obtaining an encoded distance value by encoding the distance value using quasi-uniform coding using an alphabet having a size of the parameter;
including the encoded block data in an encoded bitstream; and
outputting the encoded bitstream.

2. The method of claim 1, wherein encoding the shell index includes using a Rice-Golomb coder, an Exp-Golomb coder, or a multiclass adaptive entropy coder, and encoding the distance value includes using a quasi-uniform code using a n-ary alphabet.

3. (canceled)

4. The method of claim 1, wherein encoding the distance value includes using adaptive entropy coding by:
dividing a range from zero to a result of subtracting one from the shell index into a defined cardinality of range-classes;
determining a range-class identifier of a range-class from the range-classes in accordance with the distance value;
adaptive entropy coding the range-class identifier; and
quasi-uniform coding an index of the distance value within the range-class.

5. The method of claim 1, wherein encoding the shell index includes:
obtaining, as a shell class index, a result of a sum of one and a result of a ceiling of a base two logarithm of the shell index;
in response to a determination that the shell class index is less than two, using the shell class index as a base value for the shell class index;
in response to a determination that the shell class index is at least two, using, as a base value for the shell class index, a result of adding one to a result of left shifting one by a result of subtracting two from the shell class index;
obtaining, as a shell offset index, a result of subtracting the base value from the shell index;
encoding the shell class index;
in response to a determination that the shell class index is greater than two, encoding the shell offset index using an alphabet having a size of a result of subtracting two from the shell class index.

6. The method of claim 1, wherein encoding the current block includes:
determining that a coding mode for the current block is a compound coding mode that includes encoding the motion vector difference and a second motion vector difference obtained by subtracting a second predicted motion vector from a second motion vector used to encode the current block; and
in response to determining that the coding mode for the current block is the compound coding mode, encoding the second motion vector difference independently of encoding the motion vector difference.

7. (canceled)

8. The method of claim 6, wherein encoding the second motion vector difference independently of encoding the motion vector difference includes:
obtaining the second motion vector difference by subtracting a second predicted motion vector from a second motion vector used to encode the current block; and
encoding the second motion vector difference by:
determining a second shell index as a sum of an absolute value of a horizontal component of the second motion vector difference and an absolute value of a vertical component of the second motion vector difference;
encoding the second shell index;
in response to a determination that the second shell index is greater than zero:
determining a second quadrant value in accordance with the second motion vector;
encoding the second quadrant value using adaptive entropy coding using the alphabet having the size of four;
in response to a determination that the second shell index is greater than one:
determining, as a second distance value, a result of subtracting a remainder of dividing the second quadrant value by two from the absolute value of the vertical component of the second motion vector difference;
encoding the second distance value using quasi-uniform coding using an alphabet having a size of the second shell index.

9. (canceled)

10. The method of claim 6, wherein encoding the motion vector difference includes, in response to determining that the coding mode for the current block is the compound coding mode, encoding the second motion vector difference jointly with encoding the motion vector difference.

11. The method of claim 10, wherein:
determining the shell index includes determining the shell index as a sum of the absolute value of the horizontal component of the motion vector difference, the absolute value of the vertical component of the motion vector difference, an absolute value of a horizontal component of the second motion vector difference, and an absolute value of a vertical component of the second motion vector difference;
in response to the determination that the shell index is greater than zero:
determining a second shell index as a sum of the absolute value of the horizontal component of the motion vector difference and the absolute value of the vertical component of the motion vector difference;
encoding the second shell index using an alphabet having a size of a result of adding one to the shell index;
the determination that the parameter is greater than one omits using the shell index as the parameter and includes using the second shell index as the parameter;
determining a second quadrant value in accordance with the second motion vector;
encoding the second quadrant value using adaptive entropy coding using the alphabet having the size of four;
in response to a determination that a result of subtracting the second shell index from the shell index is greater than one:
determining, as a distance value, a result of subtracting a remainder of dividing the quadrant value by two from the absolute value of the vertical component of the motion vector difference;
encoding the distance value using quasi-uniform coding using an alphabet having a size of the result of subtracting the second shell index from the shell index.

12. The method of claim 1, wherein encoding the current block includes:
obtaining a companding zone index for a companding zone for the motion vector at a precision, wherein the companding zone includes a plurality of available precisions that includes the precision;
encoding the companding zone index;
encoding the precision; and
encoding the shell index at the precision and within the companding zone.

13. (canceled)

14. (canceled)

15. A method comprising:
generating reconstructed block data by decoding a current block from a current frame from an encoded bitstream, wherein decoding the current block includes obtaining a motion vector for decoding the current block by:
obtaining a shell index by decoding the shell index from the encoded bitstream;
in response to a determination that the shell index is zero, using a zero motion vector as a motion vector difference; and
in response to a determination that the shell index is greater than zero:
obtaining a quadrant value by decoding the quadrant value from the encoded bitstream;
in response to a determination that the shell index is less than or equal to one, identifying a distance value of zero;
in response to a determination that the shell index is greater than one, identifying the distance value by decoding the distance value from the encoded bitstream;
in response to a determination that the quadrant value is zero:
identify the distance value as a vertical component of the motion vector difference; and
identifying a result of subtracting the distance value from the shell index as a horizontal component of the motion vector difference;
in response to a determination that the quadrant value is one:
identify, as the vertical component of the motion vector difference, a sum of one and the distance value; and
identifying, as the horizontal component of the motion vector difference, a sum of one, the distance value, and an additive inverse of the shell index;
in response to a determination that the quadrant value is two:
identify, as the vertical component of the motion vector difference, an additive inverse of the distance value; and
identifying, as the horizontal component of the motion vector difference, a sum of the distance value, and an additive inverse of the shell index; and
in response to a determination that the quadrant value is three:
identify, as the vertical component of the motion vector difference, a result of subtracting one from an additive inverse of the distance value; and
identifying, as the horizontal component of the motion vector difference, a result of subtracting one from a result of subtracting the distance value from the shell index; and
obtaining, as the motion vector, a sum of the motion vector difference and a predicted motion vector;
including the reconstructed block data in a reconstructed frame; and
outputting the reconstructed frame.

16. The method of claim 15, wherein decoding the shell index includes using a Rice-Golomb coder, an Exp-Golomb coder, or a multiclass adaptive entropy coder.

17. The method of claim 15, wherein decoding the distance value includes one of:
using a quasi-uniform code using a n-ary alphabet, or
using adaptive entropy coding by:
dividing a range from zero to a result of subtracting one from the shell index into a defined cardinality of range-classes;
determining a range-class identifier of a range-class from a defined cardinality of range-classes by decoding the range-class identifier using adaptive entropy coding; and
determining an index of the distance value within the range-class by decoding the index of the distance value using quasi-uniform coding.

18. (canceled)

19. The method of claim 15, wherein decoding the shell index includes:
obtaining a shell class index by decoding the shell class index from the encoded bitstream;
in response to a determination that the shell class index is greater than two:
obtaining a shell offset index by decoding the shell offset index from the encoded bitstream; and
using, as a base value for the shell class index, a result of adding one to a result of left shifting one by a result of subtracting two from the shell class index;
in response to a determination that the shell class index is less than or equal to two:
using zero as the shell offset index; and
using the shell class index as the base value; and
obtaining, as the shell index, a sum of the base value and the shell offset index.

20. The method of claim 15, wherein decoding the current block includes:
determining that a coding mode for the current block is a compound coding mode that includes decoding the motion vector difference and a second motion vector difference; and
in response to determining that the coding mode for the current block is the compound coding mode, decoding the second motion vector difference independently of decoding the motion vector difference.

21. (canceled)

22. The method of claim 20, wherein decoding the second motion vector difference independently of decoding the motion vector difference includes:
obtaining a second shell index by decoding the second shell index from the encoded bitstream;
in response to a determination that the second shell index is zero, using the zero motion vector as the second motion vector difference; and
in response to a determination that the second shell index is greater than zero:
obtaining a second quadrant value by decoding the second quadrant value from the encoded bitstream;
in response to a determination that the second shell index is less than or equal to one, identifying a second distance value of zero;
in response to a determination that the second shell index is greater than one, identifying the second distance value by decoding the second distance value from the encoded bitstream; and
in response to a determination that the second quadrant value is zero:
identify the second distance value as a vertical component of the second motion vector difference; and
identifying a result of subtracting the second distance value from the second shell index as a horizontal component of the second motion vector difference;
in response to a determination that the second quadrant value is one:
identify, as the vertical component of the second motion vector difference, a sum of one and the second distance value; and
identifying, as the horizontal component of the second motion vector difference, a sum of one, the second distance value, and an additive inverse of the second shell index;
in response to a determination that the second quadrant value is two:
identify, as the vertical component of the second motion vector difference, an additive inverse of the second distance value; and
identifying, as the horizontal component of the second motion vector difference, a sum of the second distance value, and an additive inverse of the second shell index; and
in response to a determination that the second quadrant value is three:
identify, as the vertical component of the second motion vector difference, a result of subtracting one from an additive inverse of the second distance value; and
identifying, as the horizontal component of the second motion vector difference, a result of subtracting one from a result of subtracting the second distance value from the second shell index.

23. (canceled)

24. The method of claim 20, wherein decoding the motion vector difference includes, in response to determining that the coding mode for the current block is the compound coding mode, decoding the second motion vector difference jointly with decoding the motion vector difference.

25. The method of claim 24, wherein:
obtaining a second shell index by decoding the second shell index from the encoded bitstream;
in response to a determination that the second shell index is zero, using the zero motion vector as the second motion vector; and
in response to a determination that the second shell index is greater than zero:
obtaining a second quadrant value by decoding the second quadrant value from the encoded bitstream;
in response to a determination that the shell index is less than or equal to one, identifying a distance value of zero;
in response to a determination that the shell index is greater than one, identifying the distance value by decoding the distance value from the encoded bitstream;
in response to a determination that the quadrant value is zero:
identify the distance value as a vertical component of the motion vector; and
identifying a result of subtracting the distance value from the shell index as a horizontal component of the motion vector;
in response to a determination that the quadrant value is one:
identifying, as the vertical component of the motion vector, a sum of one and the distance value; and
identifying, as the horizontal component of the motion vector, a sum of one, the distance value, and an additive inverse of the shell index;
in response to a determination that the quadrant value is two:
identifying, as the vertical component of the motion vector, an additive inverse of the distance value; and
identifying, as the horizontal component of the motion vector, a sum of the distance value, and an additive inverse of the shell index; and
in response to a determination that the quadrant value is three:
identifying, as the vertical component of the motion vector, a result of subtracting one from an additive inverse of the distance value; and
identifying, as the horizontal component of the motion vector, a result of subtracting one from a result of subtracting the distance value from the shell index;
including the reconstructed block data in a reconstructed frame; and
outputting the reconstructed frame.

26. The method of claim 15, wherein decoding the current block includes:
obtaining a companding zone index for a companding zone for the motion vector at a precision, wherein the companding zone includes a plurality of available precisions that includes the precision, by decoding the companding zone index from the encoded bitstream;
obtaining the precision, by decoding the precision from the encoded bitstream; and
obtaining the shell index at the precision and within the companding zone, by decoding the shell index from the encoded bitstream.

27. An apparatus comprising:
a non-transitory computer-readable storage medium; and
a processor configured to execute instructions stored on the non-transitory computer-readable storage medium to implement the method of claim 15.

28. A non-transitory computer-readable storage medium having stored thereon an encoded bitstream, wherein the encoded bitstream is configured for decoding by the method of claim 15.
